(19) United States
(12) Patent Application Publication
(10) Pub. No.: US 2024/0147469 A1
(43) Pub. Date: May 2, 2024

(54) UPLINK AND DOWNLINK TRAFFIC ALIGNMENT FOR POWER SAVINGS

(71) Applicant: QUALCOMM Incorporated, San Diego, CA (US)

(72) Inventors: Prashanth Haridas HANDE, San Diego, CA (US); Ravi AGARWAL, San Diego, CA (US); Vinay MELKOTE KRISHNAPRASAD, Bangalore (IN); Peerapol TINNAKORNSRISUPHAP, San Diego, CA (US); Mickael MONDET, Louannec (FR)

(21) Appl. No.: 18/548,187

(22) PCT Filed: May 3, 2022
(86) PCT No.: PCT/US2022/072083

§ 371 Date: Aug. 28, 2023

(30) Foreign Application Priority Data
Jun. 2, 2021 (IN) 202141024529

(51) Int. Cl. H04W 72/1268; H04W 76/28

(52) U.S. Cl. CPC H04W 72/1268; H04W 76/28

(57) ABSTRACT

Various aspects of the present disclosure generally relate to wireless communication. In some aspects, a user equipment (UE) may receive, from a base station, information identifying uplink and downlink transmission opportunities that are based at least in part on downlink traffic from an application server. The UE may communicate the uplink and downlink transmission opportunities to an application client connected to the UE via a cross-layer application programming interface (API). The UE may transmit one or more uplink communications including traffic from the application client in one or more of the uplink and downlink transmission opportunities. Numerous other aspects are described.

### CROSS-REFERENCE TO RELATED APPLICATION

This Patent Application claims priority to Indian Provisional Patent Application No. 202141024529, filed on Jun. 2, 2021, entitled “UPLINK AND DOWNLINK TRAFFIC ALIGNMENT FOR POWER SAVINGS,” which is hereby expressly incorporated by reference herein.

### FIELD OF THE DISCLOSURE

Aspects of the present disclosure generally relate to wireless communication and to techniques and apparatuses for uplink and downlink traffic alignment for power savings.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BSs) that can support communication for a number of user equipment (UEs). A UE may communicate with a BS via the downlink and uplink. “Downlink” (or “forward link”) refers to the communication link from the BS to the UE, and “uplink” (or “reverse link”) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, or the like.

The above multiple access technologies have been adopted in various telecommunication standards to provide a common protocol that enables different user equipment to communicate on a municipal, national, regional, and even global level. NR, which may also be referred to as 5G, is a set of enhancements to the LTE mobile standard promulgated by the 3GPP. NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a user equipment (UE) for wireless communication includes memory, one or more processors coupled to the memory, and instructions stored in the memory and operable, when executed by the one or more processors, to cause the UE to: receive, from a base station, information identifying uplink and downlink transmission opportunities that are based at least in part on downlink traffic from an application server; communicate the uplink and downlink transmission opportunities to an application client connected to the UE via a cross-layer application programming interface (API); and transmit one or more uplink communications including traffic from the application client in one or more of the uplink and downlink transmission opportunities.

In some aspects, a UE for wireless communication includes memory, one or more processors coupled to the memory, and instructions stored in the memory and operable, when executed by the one or more processors, to cause the UE to: transmit, to a base station, uplink transmissions including traffic from an application client connected to the UE; and transmit, to the base station, information identifying uplink and downlink transmission opportunities that are based at least in part on the uplink transmissions including the traffic from the application client.

In some aspects, a method of wireless communication performed by a UE includes receiving, from a base station, information identifying uplink and downlink transmission opportunities that are based at least in part on downlink traffic from an application server; communicating the uplink and downlink transmission opportunities to an application client connected to the UE via a cross-layer API; and transmitting one or more uplink communications including traffic from the application client in one or more of the uplink and downlink transmission opportunities.

In some aspects, a method of wireless communication performed by a UE includes transmitting, to a base station, uplink transmissions including traffic from an application client connected to the UE; and transmitting, to the base station, information identifying uplink and downlink transmission opportunities that are based at least in part on the uplink transmissions including the traffic from the application client.

In some aspects, a non-transitory computer-readable medium stores one or more instructions for wireless communication that, when executed by one or more processors of a UE, cause the UE to: receive, from a base station, information identifying uplink and downlink transmission opportunities that are based at least in part on downlink traffic from an application server; communicate the uplink and downlink transmission opportunities to an application client connected to the UE via a cross-layer API; and transmit one or more uplink communications including traffic from the application client in one or more of the uplink and downlink transmission opportunities.

In some aspects, a non-transitory computer-readable medium stores one or more instructions for wireless communication that, when executed by one or more processors of a UE, cause the UE to: transmit, to a base station, uplink transmissions including traffic from an application client connected to the UE; and transmit, to the base station, information identifying uplink and downlink transmission opportunities that are based at least in part on the uplink transmissions including the traffic from the application client.

In some aspects, an apparatus for wireless communication includes means for receiving, from a base station, information identifying uplink and downlink transmission opportunities that are based at least in part on downlink traffic from an application server; means for communicating the uplink and downlink transmission opportunities to an application client via a cross-layer API; and means for transmitting one or more uplink communications including traffic from the application client in one or more of the uplink and downlink transmission opportunities.

In some aspects, an apparatus for wireless communication includes means for transmitting, to a base station, uplink transmissions including traffic from an application client; and means for transmitting, to the base station, information identifying uplink and downlink transmission opportunities that are based at least in part on the uplink transmissions including the traffic from the application client.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, or artificial intelligence-enabled devices). Aspects may be implemented in chip-level components, modular components, non-modular components, non-chip-level components, device-level components, or system-level components. Devices incorporating described aspects and features may include additional components and features for implementation and practice of claimed and described aspects. For example, transmission and reception of wireless signals may include a number of components for analog and digital purposes (e.g., hardware components including antennas, radio frequency (RF) chains, power amplifiers, modulators, buffers, processor(s), interleavers, adders, or summers). It is intended that aspects described herein may be practiced in a wide variety of devices, components, systems, distributed arrangements, or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of a split-rendering extended reality (XR) system, in accordance with the present disclosure.

FIG. 4 is a diagram illustrating an example of uplink and downlink traffic for split-rendering XR, in accordance with the present disclosure.

FIGS. 5-7 are diagrams illustrating examples associated with uplink and downlink traffic alignment for power savings, in accordance with the present disclosure.

FIGS. 8-11 are diagrams illustrating example processes associated with uplink and downlink traffic alignment for power savings, in accordance with the present disclosure.

FIGS. 12-13 are block diagrams of example apparatuses for wireless communication, in accordance with the present disclosure.

### DETAILED DESCRIPTION

In a wireless communication system, such as a split rendering extended reality (XR) system, techniques to reduce latency for uplink and downlink communications may result in smaller gaps in which a user equipment (UE) may enter a sleep state, thus leading to increased power consumption for the UE. A UE may be configured with a connected mode discontinuous reception (CDRX) cycle. In some cases, when an arrival of traffic to be transmitted in an uplink communication occurs while the UE is in a CDRX OFF time, the UE may buffer the traffic until a next CDRX ON time in order to avoid breaking the CDRX cycle and reduce power consumption. However, buffering the uplink data until the next CDRX ON time may incur a significant latency increase, which may lead to poor performance in a split rendering XR system.

Some techniques and apparatuses described herein enable alignment of uplink and downlink traffic for power savings. In some aspects, a base station may transmit, to a UE, information identifying uplink and downlink transmission opportunities that are based at least in part on downlink traffic from an application server. The UE may communicate the transmission opportunities to an application client via a cross-layer application programming interface (API). The application client may alter the arrival times for uplink traffic to match the transmission opportunities, and the UE may transmit uplink communications including the uplink traffic from the application client in the transmission opportunities. In some aspects, a UE may transmit, to a base station, information identifying uplink and downlink transmission opportunities that are based at least in part on uplink traffic from an application client. The base station may communicate the transmission opportunities to an application server via a network exposure function (NEF) API, which may cause the application server to alter arrival times of downlink traffic to match the transmission opportunities. The base station may transmit, to the UE, downlink communications including the downlink traffic from the application server in the transmission opportunities. As a result, uplink and downlink transmissions may be aligned or grouped, resulting in larger gaps between the groupings of uplink and downlink transmissions. This may allow the UE to enter a sleep state (e.g., CDRX OFF) during such gaps, and therefore may reduce power consumption of the UE without increased latency due to increased buffering of the uplink communications.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof Whether such elements are implemented as hardware or software depends upon the particular application and design constraints imposed on the overall system.

It should be noted that while aspects may be described herein using terminology commonly associated with a 5G or NR radio access technology (RAT), aspects of the present disclosure can be applied to other RATs, such as a 3G RAT, a 4G RAT, and/or a RAT subsequent to 5G (e.g., 6G).

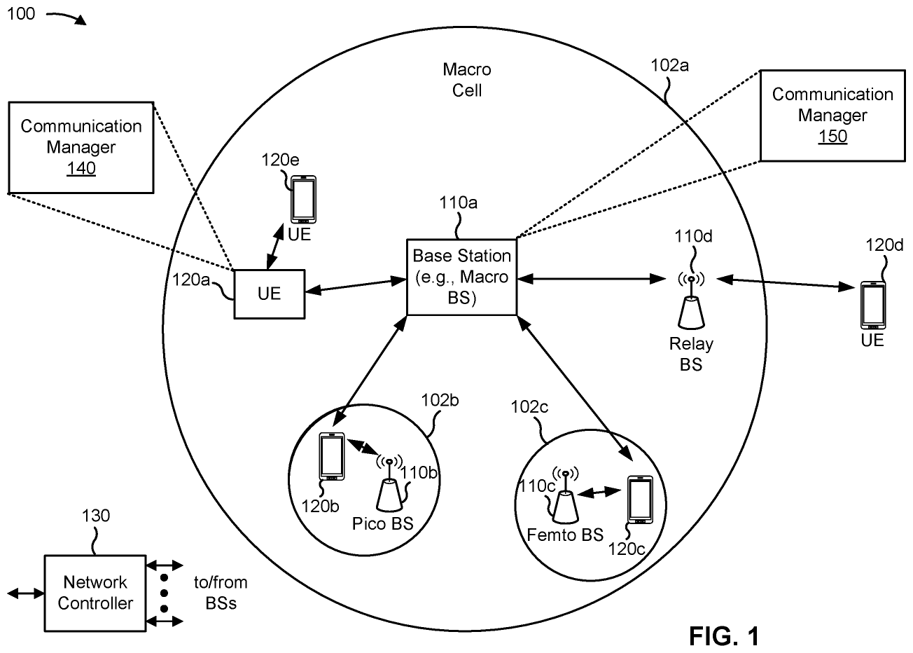

FIG. 1 is a diagram illustrating an example of a wireless network 100, in accordance with the present disclosure. The wireless network 100 may be or may include elements of a 5G (NR) network and/or an LTE network, among other examples. The wireless network 100 may include a number of base stations 110 (shown as BS 110a, BS 110b, BS 110c, and BS 110d) and other network entities. A base station (BS) is an entity that communicates with user equipment (UEs) and may also be referred to as an NR BS, a Node B, a gNB, a 5G node B (NB), an access point, a transmit receive point (TRP), or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces, such as a direct physical connection or a virtual network, using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay BS 110d may communicate with macro BS 110a and a UE 120d in order to facilitate communication between BS 110a and UE 120d. A relay BS may also be referred to as a relay station, a relay base station, a relay, or the like.

Wireless network 100 may be a heterogeneous network that includes BSs of different types, such as macro BSs, pico BSs, femto BSs, relay BSs, or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, and/or location tags, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components and/or memory components. In some aspects, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks may be deployed in a given geographic area. Each wireless network may support a particular RAT and may operate on one or more frequencies. A RAT may also be referred to as a radio technology, an air interface, or the like. A frequency may also be referred to as a carrier, a frequency channel, or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol or a vehicle-to-infrastructure (V2I) protocol), and/or a mesh network. In this case, the UE 120 may perform scheduling operations, resource selection operations, and/or other operations described elsewhere herein as being performed by the base station 110.

Devices of wireless network 100 may communicate using the electromagnetic spectrum, which may be subdivided based on frequency or wavelength into various classes, bands, channels, or the like. For example, devices of wireless network 100 may communicate using an operating band having a first frequency range (FR1), which may span from 410 MHz to 7.125 GHz, and/or may communicate using an operating band having a second frequency range (FR2), which may span from 24.25 GHz to 52.6 GHz. The frequencies between FR1 and FR2 are sometimes referred to as mid-band frequencies. Although a portion of FR1 is greater than 6 GHz, FR1 is often referred to as a “sub-6 GHz” band. Similarly, FR2 is often referred to as a “millimeter wave” band despite being different from the extremely high frequency (EHF) band (30 GHz-300 GHz) which is identified by the International Telecommunications Union (ITU) as a “millimeter wave” band. Thus, unless specifically stated otherwise, it should be understood that the term “sub-6 GHz” or the like, if used herein, may broadly represent frequencies less than 6 GHz, frequencies within FR1, and/or mid-band frequencies (e.g., greater than 7.125 GHz). Similarly, unless specifically stated otherwise, it should be understood that the term “millimeter wave” or the like, if used herein, may broadly represent frequencies within the EHF band, frequencies within FR2, and/or mid-band frequencies (e.g., less than 24.25 GHz). It is contemplated that the frequencies included in FR1 and FR2 may be modified, and techniques described herein are applicable to those modified frequency ranges.

In some aspects, the UE 120 may include a communication manager 140. As described in more detail elsewhere herein, the communication manager 140 may receive, from a base station, information identifying uplink and downlink transmission opportunities that are based at least in part on downlink traffic from an application server; communicate the uplink and downlink transmission opportunities to an application client connected to the UE via a cross-layer API; and transmit one or more uplink communications including traffic from the application client in one or more of the uplink and downlink transmission opportunities. Additionally, or alternatively, the communication manager 140 may perform one or more other operations described herein.

In some aspects, as described in more detail elsewhere herein, the communication manager 140 may transmit, to a base station, uplink transmissions including traffic from an application client connected to the UE; and transmit, to the base station, information identifying uplink and downlink transmission opportunities that are based at least in part on the uplink transmissions including the traffic from the application client. Additionally, or alternatively, the communication manager 140 may perform one or more other operations described herein.

In some aspects, the base station 110 may include a communication manager 150. As described in more detail elsewhere herein, the communication manager 150 may transmit, to a UE, downlink transmissions including traffic from an application server; and transmit, to the UE, information identifying uplink and downlink transmission opportunities that are based at least in part on the downlink transmissions including the traffic from the application server. Additionally, or alternatively, the communication manager 150 may perform one or more other operations described herein.

In some aspects, as described in more detail elsewhere herein, the communication manager 150 may transmit, to an application server via an NEF API, information identifying uplink and downlink transmission opportunities based at least in part on uplink transmissions, received from a UE, of traffic from an application client connected to the UE; and transmit, to the UE, one or more downlink communications including traffic from the application server in one or more of the uplink and downlink transmission opportunities. Additionally, or alternatively, the communication manager 150 may perform one or more other operations described herein.

As indicated above, FIG. 1 is provided as an example. Other examples may differ from what is described with regard to FIG. 1.

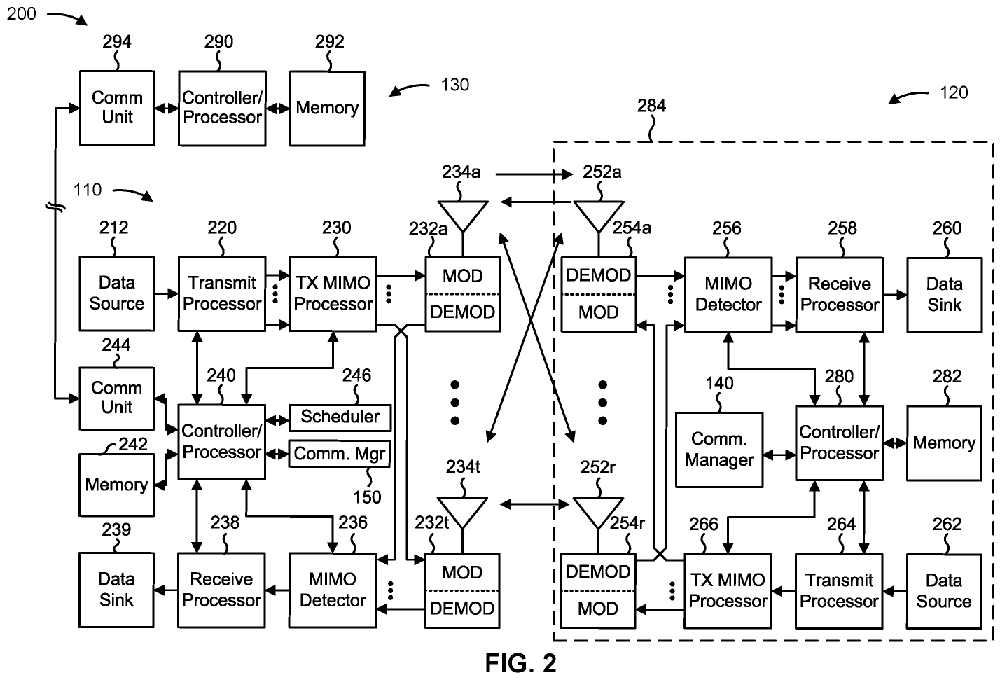

FIG. 2 is a diagram illustrating an example 200 of a base station 110 in communication with a UE 120 in a wireless network 100, in accordance with the present disclosure. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI)) and control information (e.g., CQI requests, grants, and/or upper layer signaling) and provide overhead symbols and control symbols. Transmit processor 220 may also generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some aspects, one or more components of UE 120 may be included in a housing 284.

Network controller 130 may include communication unit 294, controller/processor 290, and memory 292. Network controller 130 may include, for example, one or more devices in a core network. Network controller 130 may communicate with base station 110 via communication unit 294.

Antennas (e.g., antennas 234a through 234t and/or antennas 252a through 252r) may include, or may be included within, one or more antenna panels, antenna groups, sets of antenna elements, and/or antenna arrays, among other examples. An antenna panel, an antenna group, a set of antenna elements, and/or an antenna array may include one or more antenna elements. An antenna panel, an antenna group, a set of antenna elements, and/or an antenna array may include a set of coplanar antenna elements and/or a set of non-coplanar antenna elements. An antenna panel, an antenna group, a set of antenna elements, and/or an antenna array may include antenna elements within a single housing and/or antenna elements within multiple housings. An antenna panel, an antenna group, a set of antenna elements, and/or an antenna array may include one or more antenna elements coupled to one or more transmission and/or reception components, such as one or more components of FIG. 2.

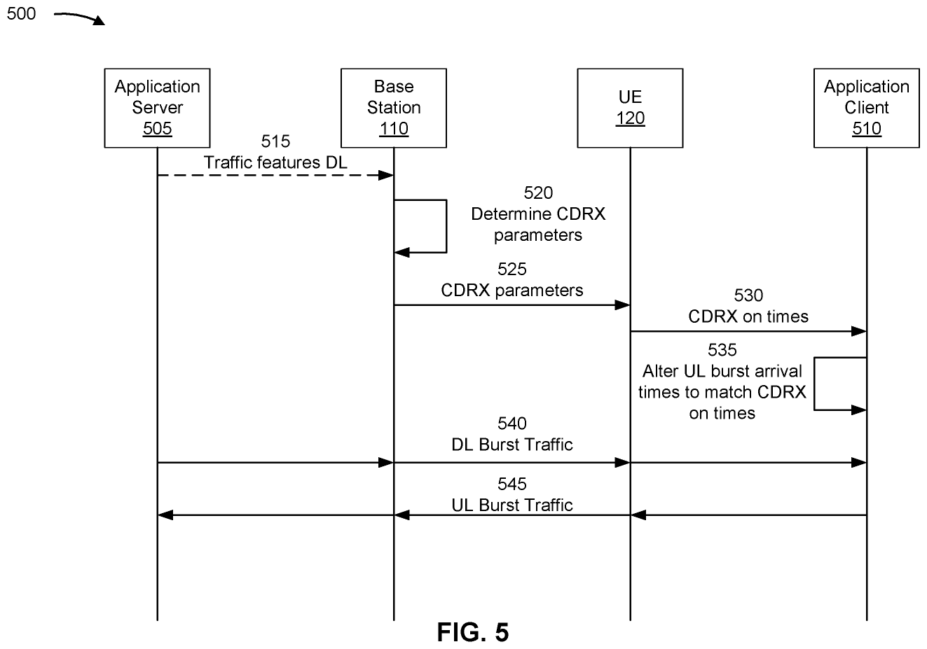

On the uplink, at UE 120, a transmit processor 264 may receive and process data from a data source 262 and control information (e.g., for reports that include RSRP, RSSI, RSRQ, and/or CQI) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM or CP-OFDM), and transmitted to base station 110. In some aspects, a modulator and a demodulator (e.g., MOD/DEMOD 254) of the UE 120 may be included in a modem of the UE 120. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein (for example, as described with reference to FIGS. 5-11).

At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and/or uplink communications. In some aspects, a modulator and a demodulator (e.g., MOD/DEMOD 232) of the base station 110 may be included in a modem of the base station 110. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein (for example, as described with reference to FIGS. 5-11).

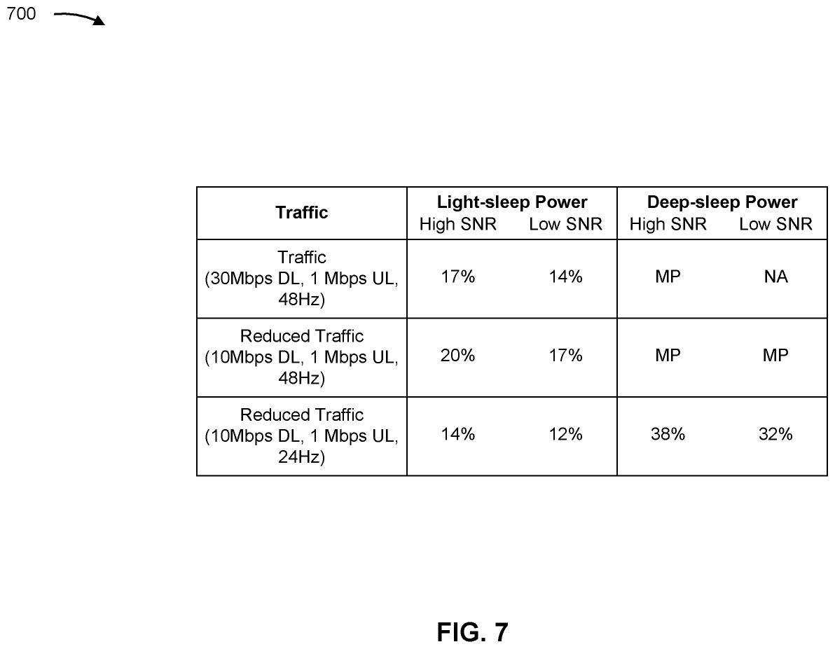

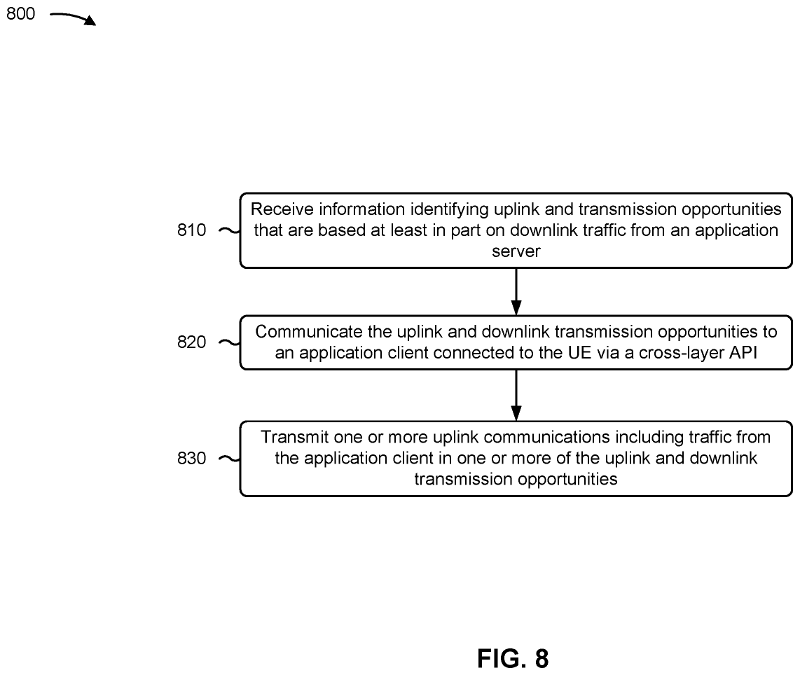

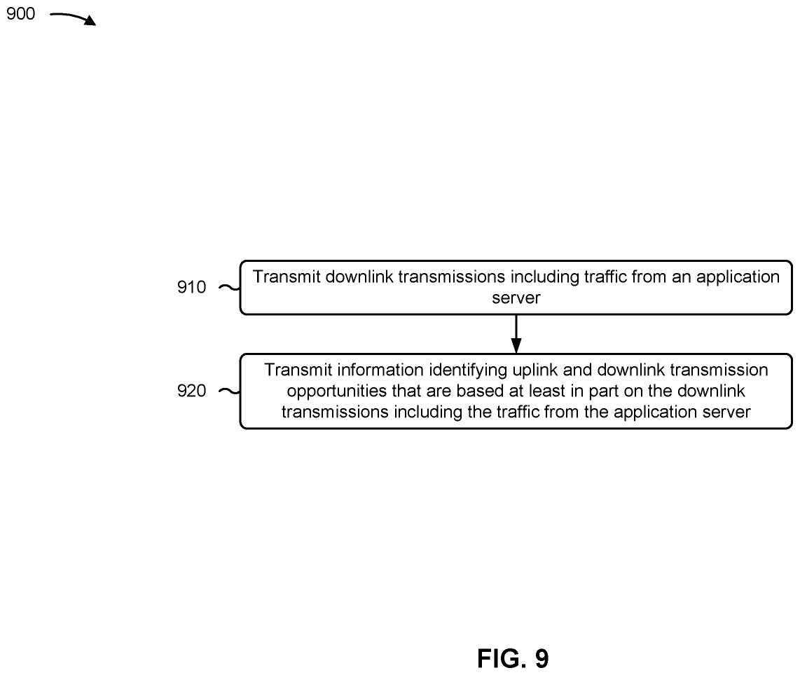

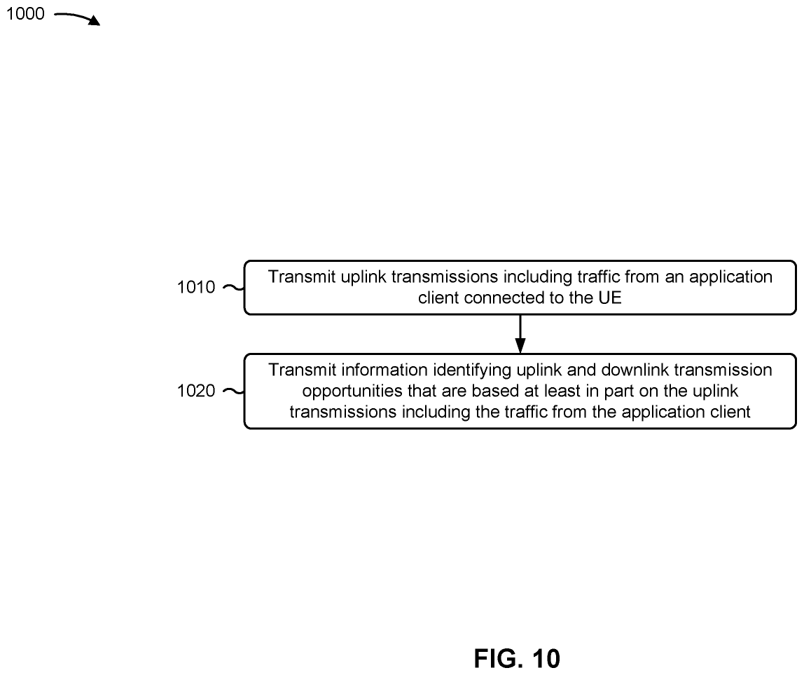

Controller/processor 240 of base station 110, controller/processor 280 of UE 120, and/or any other component(s) of FIG. 2 may perform one or more techniques associated with uplink and downlink alignment for power savings, as described in more detail elsewhere herein. For example, controller/processor 240 of base station 110, controller/processor 280 of UE 120, and/or any other component(s) of FIG. 2 may perform or direct operations of, for example, process 700 of FIG. 7, process 800 of FIG. 8, process 900 of FIG. 9, process 1000 of FIG. 10, and/or other processes as described herein. Memories 242 and 282 may store data and program codes for base station 110 and UE 120, respectively. In some aspects, memory 242 and/or memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 700 of FIG. 7, process 800 of FIG. 8, process 900 of FIG. 9, process 1000 of FIG. 10, and/or other processes as described herein. In some aspects, executing instructions may include running the instructions, converting the instructions, compiling the instructions, and/or interpreting the instructions, among other examples.

In some aspects, the UE 120 includes means for receiving, from a base station, information identifying uplink transmission opportunities that are aligned with downlink transmissions of traffic from an application server; means for communicating the uplink transmission opportunities to an application client running on the UE via a cross-layer API; and/or means for transmitting one or more uplink communications including traffic from the application client in one or more of the uplink transmission opportunities. The means for the UE 120 to perform operations described herein may include, for example, one or more of communication manager 140, antenna 252, demodulator 254, MIMO detector 256, receive processor 258, transmit processor 264, TX MIMO processor 266, modulator 254, controller/processor 280, or memory 282.

In some aspects, the base station 110 includes means for transmitting, to a UE, downlink transmissions including traffic from an application server; and/or means for transmitting, to the UE, information identifying uplink transmission opportunities that are aligned with the downlink transmissions including the traffic from the application server. The means for the base station 110 to perform operations described herein may include, for example, one or more of communication manager 150, transmit processor 220, TX MIMO processor 230, modulator 232, antenna 234, demodulator 232, MIMO detector 236, receive processor 238, controller/processor 240, memory 242, or scheduler 246.

In some aspects, the UE 120 includes means for receiving, from a base station, information identifying uplink and downlink transmission opportunities that are based at least in part on downlink traffic from an application server; means for communicating the uplink and downlink transmission opportunities to an application client connected to the UE via a cross-layer API; and/or means for transmitting, to the base station, information identifying downlink transmission opportunities that are aligned with the uplink transmissions including the traffic from the application client. The means for the UE 120 to perform operations described herein may include, for example, one or more of communication manager 140, antenna 252, demodulator 254, MIMO detector 256, receive processor 258, transmit processor 264, TX MIMO processor 266, modulator 254, controller/processor 280, or memory 282

In some aspects, the UE 120 includes means for transmitting, to a base station, uplink transmissions including traffic from an application client connected to the UE; and/or means for transmitting, to the base station, information identifying uplink and downlink transmission opportunities that are based at least in part on the uplink transmissions including the traffic from the application client. The means for the UE 120 to perform operations described herein may include, for example, one or more of communication manager 140, antenna 252, demodulator 254, MIMO detector 256, receive processor 258, transmit processor 264, TX MIMO processor 266, modulator 254, controller/processor 280, or memory 282.

In some aspects, the base station 110 includes means for transmitting, to a UE, downlink transmissions including traffic from an application server; and/or means for transmitting, to the UE, information identifying uplink and downlink transmission opportunities that are based at least in part on the downlink transmissions including the traffic from the application server. The means for the base station 110 to perform operations described herein may include, for example, one or more of communication manager 150, transmit processor 220, TX MIMO processor 230, modulator 232, antenna 234, demodulator 232, MIMO detector 236, receive processor 238, controller/processor 240, memory 242, or scheduler 246.

In some aspects, the base station 110 includes means for transmitting, to an application server via an NEF API, information identifying uplink and downlink transmission opportunities based at least in part on uplink transmissions, received from a UE, of traffic from an application client connected to the UE; and/or means for transmitting, to the UE, one or more downlink communications including traffic from the application server in one or more of the uplink and downlink transmission opportunities. The means for the base station 110 to perform operations described herein may include, for example, one or more of communication manager 150, transmit processor 220, TX MIMO processor 230, modulator 232, antenna 234, demodulator 232, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of controller/processor 280.

As indicated above, FIG. 2 is provided as an example. Other examples may differ from what is described with regard to FIG. 2.

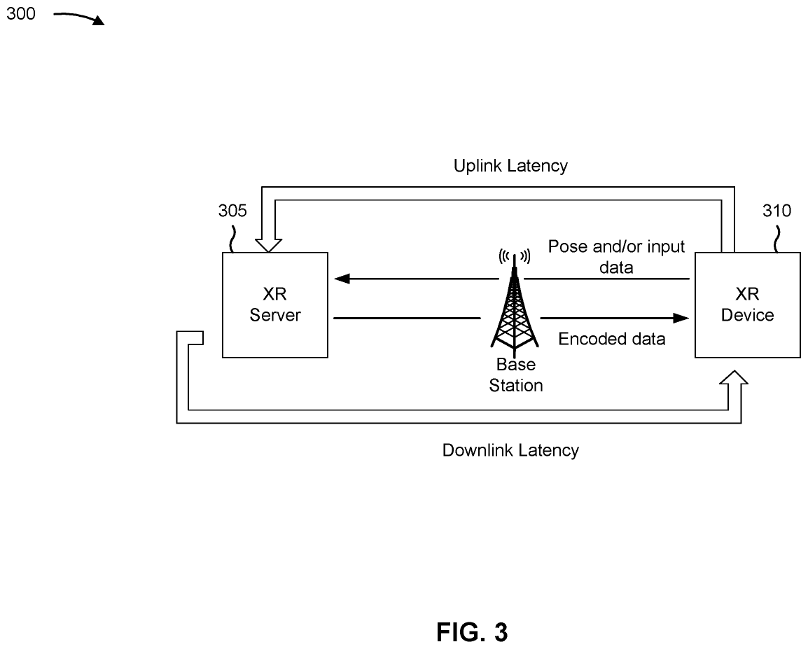

FIG. 3 is a diagram illustrating an example 300 of a split-rendering XR system, in accordance with the present disclosure. XR is an umbrella term encapsulating augmented reality (AR), virtual reality (VR), mixed reality (MR), or any combination thereof. As shown in FIG. 3, in the split-rendering XR (or “splitXR”) system, rendering for a scene on an XR display is split between an XR server 305 and an XR device 310 that includes the XR display. For example, on-device rendering and perception processing, on the XR device 310, may be augmented by graphics rendering by the XR server via wireless network (e.g., 5G) communications. The XR server 305 may be an application server that serves an application client running on the XR device 310. In some aspects, the XR server 305 may be an edge server (or an edge cloud) connected to a base station (e.g., base station 110), such as a 5G/NR base station. The XR device may be a UE (e.g., UE 120), may be included in a UE, or may include a UE. In some aspects, the XR device may include a wearable XR headset.

As shown in FIG. 3, the XR device 310 may transmit uplink data, including user pose data and/or input data, to the XR server 305 via the base station. The user pose data may include a current pose of the XR device. For example, the user pose data may include a six degree of freedom (6-DoF) or three degree of freedom (3-DoF) pose of the XR headset, which may be tracked by sensors on the XR headset. Additionally, and/or alternatively, the uplink data may include input data, such as controller input from an XR controller. The transmission rate of the pose and controller data may be the same as a video frame rate (e.g., 90 Hz). In this case, the XR server 305 and the XR device 310 may render each video frame, displayed on a display of the XR device 310, based on the latest pose information.

The XR server 305, based at least in part on the latest pose information received in the uplink data, may generate an XR scene (e.g., an updated XR scene) and perform XR viewport pre-rendering rasterization of the XR scene. The XR server 305 may then encode the pre-rendered XR viewport as 2D media and transmit the encoded data (e.g., the 2D media for the pre-rendered viewport) to the XR device 310 via the base station (e.g., as downlink data). The XR device 310 may decode the 2D media, render the XR viewport using Asynchronous TimeWarp (ATW) rendering based on the latest pose tracking information, and display the rendered XR viewport for the updated scene of the display of the XR device 310.

To provide a good user experience, the delay from user motion to the updated scene being displayed on the display device may be minimized. In the splitXR system, this delay may correspond to the motion-to-render-to-photon (M2R2P) time. Here, “photon” refers to the display device. The M2R2P time may be equal to a sum of a 5G round trip time (5G-RTT), a client multimedia processing time (e.g., the processing time of the XR device 310), and the server multimedia processing time (e.g., the processing time of the XR server 305). The 5G-RTT may be equal to the sum of an uplink latency associated with transmitting the uplink data from the XR device 310 to the XR server 305 and a downlink latency associated with transmitting the downlink data from the XR server 305 to the XR device 310.

As indicated above, FIG. 3 is provided as an example. Other examples may differ from what is described with respect to FIG. 3.

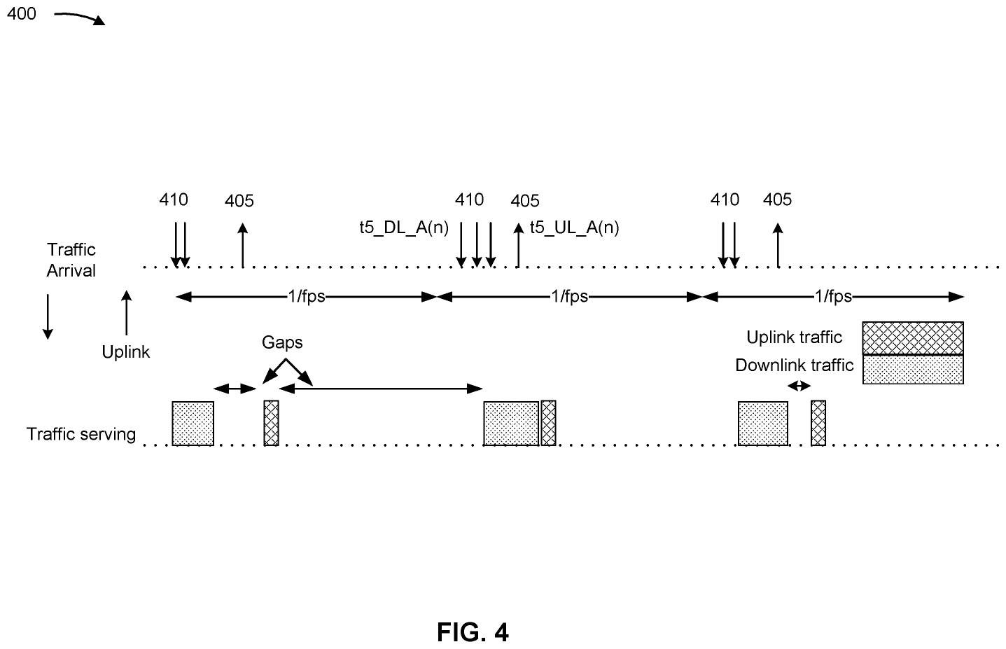

FIG. 4 is a diagram illustrating an example 400 of uplink and downlink traffic for split-rendering XR, in accordance with the present disclosure. As shown in FIG. 4, example 400 shows traffic arrivals of uplink traffic 405 and downlink traffic 410 in a split XR system. As user herein, “traffic arrival” refers to the arrival of data to be transmitted in a buffer of a wireless network device (e.g., a UE or a base station). For example, in a split XR system, the arrival of an uplink traffic burst may occur when uplink data (e.g., pose and/or control information) is output by an XR application server to a buffer of a UE/XR device to be transmitted to the XR server. In such a split XR system, the arrival of a downlink traffic burst may occur when downlink data (e.g., encoded 2D media for a pre-rendered scene) is output by the XR server and arrives in a buffer of a base station to be transmitted to a UE/XR device.

In a split XR system, various multimedia side techniques may be used to reduce the M2R2P time. In some examples, the render start time may be set based on frame repeat and ATW repeat statistics. In some examples, the render start time may be set to immediately follow pose/controller information arrival or a timeout. However, in such cases, the resulting 5G arrival times of an nth burst of uplink traffic (t5_UL_A(n)) and an nth burst of downlink traffic (t5_DL_A(n)) may be suboptimal for power consumption by the UE (e.g., XR device). For example, as shown in FIG. 4, the techniques to reduce the M2R2P time may result in smaller gaps that allow for a modem of the UE to sleep, thus leading to increased power consumption.

In some cases, the base station may configure a CDRX cycle for the UE. The CDRX cycle may include a CDRX ON duration (e.g., during which the UE is awake or in an active state) and an opportunity to enter a CDRX sleep state. As used herein, the time during which the UE is configured to be in an active state during the CDRX ON duration may be referred to as an active time or a CDRX ON time, and the time during which the UE is configured to be in the CDRX sleep state may be referred to as an inactive time or a CDRX OFF time. In some examples, in a case in which an uplink arrival occurs during a CDRX OFF time, a UE may buffer the uplink data until the next CDRX ON time in order to avoid breaking the CDRX cycle and reduce power consumption. However, buffering the uplink data until the next CDRX ON time may incur a significant latency increase, which may lead to poor performance in a split XR system.

Some techniques and apparatuses described herein enable alignment of uplink and downlink traffic for power savings. In some aspects, a base station may transmit, to a UE, information identifying uplink and downlink transmission opportunities that are based at least in part on downlink traffic from an application server. The UE may communicate the transmission opportunities to an application client via a cross-layer API. The application client may alter the arrival times for uplink traffic to match the transmission opportunities, and the UE may transmit uplink communications including the uplink traffic from the application client in the transmission opportunities. In some aspects, a UE may transmit, to a base station, information identifying uplink and downlink transmission opportunities that are based at least in part on uplink traffic from an application client. The base station may communicate the transmission opportunities to an application server via an NEF API, which may cause the application server to alter arrival times of downlink traffic to match the transmission opportunities. The base station may transmit, to the UE, downlink communications including the downlink traffic from the application server in the transmission opportunities. As a result, uplink and downlink transmissions may be aligned or grouped, resulting in larger gaps between the groupings of uplink and downlink transmissions. This may allow the UE to enter a sleep state (e.g., CDRX OFF) during such gaps, and therefore may reduce power consumption of the UE without increased latency due to increased buffering of the uplink communications.

As indicated above, FIG. 4 is provided as an example. Other examples may differ from what is described with respect to FIG. 4.

FIG. 5 is a diagram illustrating an example 500 associated with uplink and downlink traffic alignment for power savings, in accordance with the present disclosure. As shown in FIG. 5, example 500 includes communication between an application server 505, a base station 110, a UE 120, and an application client 510. In some aspects, the base station 110 and the UE 120 may be included in a wireless network, such as wireless network 100. The base station 110 and the UE 120 may communicate via a wireless access link, which may include an uplink and a downlink.

In some aspects, the application server 505 may be connected to and/or in communication with the base station 110. For example, the application server 505 may be an edge server connected to the base station 110. In some aspects, the application client 510 may be connected to the UE 120. For example, the application client 510 may be running on the UE 120, running on a same device as the UE 120, or running on a device that communicates with the base station 110 via the UE 120. In some aspects, the application client 510 may perform an XR application on an XR device (e.g., XR device 310), and the application server may be an XR server (e.g., XR server 305) that performs rendering for the XR application. In this case, the UE 120 may be the XR device, the UE 120 may include or be included on the XR device, or the UE 120 may communicate with the XR device to provide connectivity for the XR device with the base station 110.

As shown in FIG. 5, and by reference number 515, the application server 505 may send, to the base station 110, downlink traffic features associated with downlink traffic from the application server 505. In some aspects, the downlink traffic features may include one or more of a periodicity associated with the downlink traffic from the application server 505, a jitter associated with the downlink traffic, a time duration associated with the downlink traffic, and/or a burst arrival offset associated with the downlink traffic from the application. The periodicity may indicate a regular time interval between burst arrival times (t5_DL_A(n)) for the downlink traffic. The time duration may indicate a time duration for which a modem (e.g., of the base station 110 and/or the UE 120) is to be on for transmitting and/or receiving each burst of downlink traffic. The burst arrival offset may indicate a delay between the application server 505 outputting the downlink traffic and the arrival of the downlink traffic in a buffer of the base station 110. In some aspects, the application server 505 may communicate the downlink traffic features to the base station 110 via an NEF API (e.g., a 5G NEF interface) between the base station 110 and the application server 505.

In some aspects, the application server 505 may determine the downlink traffic features based at least in part on a set of initial (e.g., previous) downlink traffic bursts from the application server 505, that are transmitted by the base station 110 in downlink communications to the UE 120. For example, the application server 505 may determine the downlink traffic features based at least in part on a certain number of initial downlink traffic transmissions and/or downlink traffic transmissions within a certain time duration. In some aspects, the application server 505 may translate an application layer timing for the downlink traffic to a wireless network (e.g., 5G) timing.

In some aspects, the base station 110 may detect the downlink traffic features associated with the downlink traffic from the application server 505. For example, the base station 110 may detect the downlink traffic features (e.g., the periodicity, the jitter, the time duration, and/or the burst arrival offset) without receiving the downlink traffic features from the application server 505. In this case, the base station 110 may learn the downlink traffic features from a set of downlink transmissions of traffic from the application server 505 to the UE 120.

As further shown in FIG. 5, and by reference number 520, the base station 110 may determine CDRX parameters for the UE 120 based at least in part on the downlink traffic features associated with the downlink traffic from the application server 505. The base station 110 may identify uplink and downlink transmission opportunities based at least in part on the downlink traffic features associated with the downlink traffic from the application server 505. “Uplink and downlink transmission opportunities” (also referred to as “transmission opportunities”) refers to time occasions to be used for downlink transmissions of traffic from the application server 505 and for uplink transmissions of traffic from the application client 510. In some aspects, the base station 110 may determine the transmission opportunities to align the transmission opportunities with the downlink transmissions of traffic from the application server 505 based at least in part on the downlink traffic features. For example, the timing of the transmission opportunities may correspond to a timing (e.g., periodicity) of the downlink traffic, and the duration of each of the transmission opportunities may be long enough to allow for a burst of downlink traffic from the application server 505 to be received by the UE 120 and a burst of uplink traffic from the application client 510 to be transmitted by the UE 120.

In some aspects, as shown in FIG. 5, the transmission opportunities may include CDRX ON times of a CDRX cycle configured for the UE 120. In this case, the base station 110 may determine CDRX parameters for the UE 120 to configure the CDRX ON times for the UE 120 to be aligned with expected downlink transmissions of traffic from the application server 505. For example, the base station 110 may set the timing of the CDRX ON times to correspond with the timing for the downlink transmissions, and the base station 110 may set the duration of the CDRX ON times to allow time for uplink transmissions, as well as the expected downlink transmissions, in the CDRX ON times.

In some aspects, instead of or in addition to CDRX ON times, transmission opportunities may include times at which the UE 120 communicates with the base station 110 using a first bandwidth part (BWP). In this case, the base station 110 may determine the transmission opportunities by planning transitions for the UE 120 between the first BWP and a second BWP that is associated with a lower power consumption that the first BWP. For example, the first BWP may be a high-throughput BWP and the second BWP may be a low-power BWP. In this case, the base station 110 may plan transitions for the UE 120 to the first BWP during transmission opportunities aligned with the downlink transmissions (e.g., during times associated with the downlink transmissions), and to the second BWP during gaps between the transmission opportunities.

In some aspects, the transmission opportunities may include times associated with periodic uplink grants and/or uplink configured grants (UL-CGs). For example, the base station 110 may schedule periodic uplink grants and/or UL-CGs for the UE 120 in times that are aligned with the downlink transmissions. In some aspects, the base station 110 may schedule periodic uplink grants and/or UL-CGs for the UE 120 during a configured CDRX ON time and/or a time at which the UE 120 is switched to the first BWP (e.g., the high throughput BWP).

As further shown in FIG. 5, and by reference number 525, the base station 110 may transmit, to the UE 120, the CDRX parameters associated with the transmission opportunities determined by the base station 110. The base station 110 may transmit, to the UE 120, information that identifies the uplink and downlink transmission opportunities that are based at least in part on the downlink features of the downlink traffic from the application server 505. In some aspects, as shown in FIG. 5, the base station 110 may transmit the CDRX parameters that indicate CDRX ON times that are aligned with the downlink traffic from the application server 505. For example, the base station 110 may transmit the CDRX parameters to the UE 120 via a radio resource control (RRC) configuration.

In some aspects, the information identifying the transmission opportunities may include indications for the UE 120 to switch between the first BWP and the second BWP. For example, for each of a plurality of downlink transmissions of traffic from the application server 505, the base station 110 may transmit, to the UE 120, a respective indication to switch to the first BWP. The UE 120 may switch to the first BWP and receive the downlink transmission, and after a certain duration, the base station 110 may then transmit, to the UE 120, an indication to switch to the second BWP. For example, the base station 110 may transmit the BWP switching indications to the UE 120 in downlink control information (DCI). The UE 120 may receive the BWP switching indications from the base station 110, and the UE 120 may learn a BWP switching pattern based at least in part on the BWP switching indications. In some aspects, the UE 120 may identify the transmission opportunities (e.g., the UE 120 may predict future transmission opportunities) based at least in part on the BWP switching pattern determined from the BWP switching indications.

In some aspects, in a case in which the transmission opportunities include periodic uplink grants and/or UL-CGs, the information identifying the transmission opportunities may include scheduling information for the periodic uplink grants and/or the UL-CGs.

As further shown in FIG. 5, and by reference number 530, the UE 120 may communicate the uplink and downlink transmission opportunities (e.g., the CDRX ON times) to the application client 510 via a cross-layer API. For example, the cross-layer API may provide communication between the UE 120 and/or a modem of the UE 120 with an application layer on which the application client 510 is running In some aspects, as shown in FIG. 5, the UE 120 may expose and/or convey to the application client 510, via the cross-layer API, the CDRX ON times configured for the UE 120. For example, the UE 120 may communicate, to the application client 510, the CDRX ON times that are aligned with the downlink communications including traffic from the application server 505.

In some aspects, instead of or in addition to the CDRX ON times, the UE 120 may expose and/or convey to the application client 510, via the cross-layer API, predicted times at which the UE 120 will switch to the first BWP (e.g., the high throughput BWP) from the second BWP (e.g., the low-power BWP). For example, the predicted times may correspond to the transmission opportunities identified, by the UE 120, based at least in part on the BWP switching pattern determined from the BWP switching indications received from the base station 110.

In some aspects, the UE 120 may expose and/or convey to the application client 510, via the cross-layer API, times associated with a scheduled periodic uplink grant. For example, the UE 120 may communication, to the application client 510, times associated with a scheduled periodic uplink grant aligned with the downlink transmissions of the traffic from the application server 505. In some aspects, the UE 120 may expose and/or convey to the application client 510, via the cross-layer API, times associated with one or more scheduled UL-CGs. For example, the UE 120 may communicate, to the application client 510, times associated with one or more scheduled UL-CGs aligned with the downlink transmissions of the traffic from the application server 505.

As further shown in FIG. 5, and by reference number 535, the application client 510 may alter uplink burst arrival times (t5_UL_A(n)) to match the uplink and downlink transmission opportunities (e.g., the CDRX ON times). For example, the application client 510 may alter the arrival times of uplink traffic from the application client 510 such that arrival times, at which the application client 510 introduces/outputs the uplink traffic to a buffer of the UE 120, match the transmission opportunities. In some aspects, as shown in FIG. 5, the application client 510 may adjust the arrival times for the uplink traffic to output the uplink traffic during the CDRX ON times (e.g., the CDRX ON times that are aligned with the downlink transmissions of the traffic from the application server 505).

In some aspects, the application client 510 may alter the arrival times for the uplink traffic to match the predicted times at which the UE 120 will switch to the first BWP (e.g., the high-throughput BWP). In some aspects, the application client 510 may alter the arrival times for the uplink traffic to match times associated with scheduled periodic uplink grants (e.g., scheduled periodic uplink grants that are aligned with downlink transmissions of traffic from the application server 505). In some aspects, the application client 510 may alter the arrival times for the uplink traffic to match times associated with one or more scheduled UL-CGs (e.g., one or more scheduled UL-CGs that are aligned with downlink transmissions of traffic from the application server 505).

As further shown in FIG. 5, and by reference number 540, the base station 110 may receive downlink burst traffic from the application server 505, and the base station 110 may transmit, to the UE 120, downlink communications including the downlink burst traffic. The UE 120 may receive the downlink communications from the base station 110 and convey the downlink data included in the downlink communications to the application client 510. As shown by reference number 545, the UE 120 may receive uplink burst traffic from the application client 510, and the UE 120 may transmit, to the base station 110, uplink communications including the uplink burst traffic. The base station 110 may receive the uplink communications from the UE 120 and convey the uplink data included in the uplink communications to the application server 505. In some aspects, the uplink burst traffic and the downlink burst traffic may be transmitted in the uplink and downlink transmission opportunities. This may result in the uplink transmissions and downlink transmission being aligned (or grouped) in close proximity to each other, with gaps between grouped uplink and downlink transmissions.

As described above in connection with FIG. 5, the base station 110 may transmit, to the UE 120, information identifying uplink and downlink transmission opportunities that are based at least in part on downlink traffic from the application server 505. The UE 120 may communicate the transmission opportunities to the application client 510 via a cross-layer API. The application client 510 may alter the arrival times for uplink traffic to match the transmission opportunities, and the UE 120 may transmit uplink communications including the uplink traffic from the application client in the transmission opportunities. As a result, uplink transmissions may be aligned or grouped with the downlink transmissions, resulting in larger gaps between the groupings of uplink and downlink transmissions. This may allow the UE 120 to enter a sleep state (e.g., CDRX OFF) or a low-power state (e.g., the second BWP) during such gaps, and therefore may reduce power consumption of the UE 120 without increased latency due to increased buffering of the uplink communications.

As indicated above, FIG. 5 is provided as an example. Other examples may differ from what is described with respect to FIG. 5.

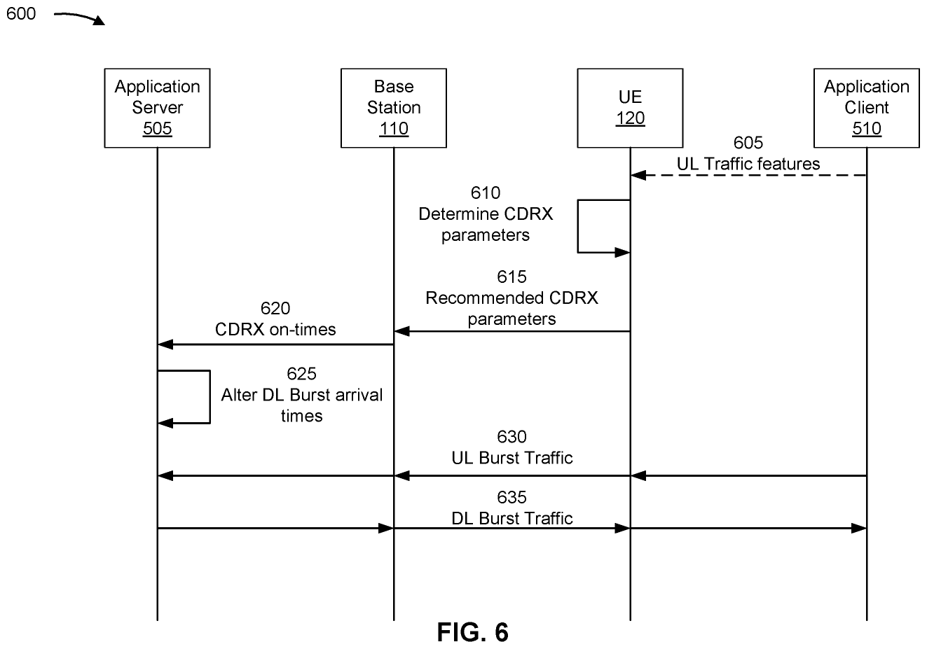

FIG. 6 is a diagram illustrating an example 600 associated with uplink and downlink traffic alignment for power savings, in accordance with the present disclosure. As shown in FIG. 6, example 600 includes communication between an application server 505, a base station 110, a UE 120, and an application client 510. In some aspects, the base station 110 and the UE 120 may be included in a wireless network, such as wireless network 100. The base station 110 and the UE 120 may communicate via a wireless access link, which may include an uplink and a downlink.

In some aspects, the application server 505 may be connected to and/or in communication with the base station 110. For example, the application server 505 may be an edge server connected to the base station 110. In some aspects, the application client 510 may be connected to the UE 120. For example, the application client 510 may be running on the UE 120, running on a same device as the UE 120, or running on a device that communicates with the base station 110 via the UE 120. In some aspects, the application client 510 may perform an XR application on an XR device (e.g., XR device 310), and the application server may be an XR server (e.g., XR server 305) that performs rendering for the XR application. In this case, the UE 120 may be the XR device, the UE 120 may include or be included on the XR device, or the UE 120 may communicate with the XR device to provide connectivity for the XR device with the base station 110.

As shown in FIG. 6, and by reference number 605, the application client 510 may communicate, to the UE 120, uplink traffic features associated with uplink traffic from the application client 510. In some aspects, the application client 510 may communicate the uplink traffic features to the UE 120 via a cross-layer API. In some aspects, the uplink traffic features may include one or more of a periodicity associated with the uplink traffic from the application client 510, a jitter associated with the uplink traffic, a time duration associated with the uplink traffic, and/or a burst arrival offset associated with the uplink traffic from the application. The periodicity may indicate a regular time interval between burst arrival times (t5_UL_A(n)) for the uplink traffic. The time duration may indicate a time duration for which the UE 120 is to be in an active mode for transmitting each burst of uplink traffic. The burst arrival offset may indicate a time delay between the application client 510 outputting the uplink traffic and the arrival of the uplink traffic in a buffer of the UE 120.

In some aspects, the application client 510 may determine the uplink traffic features based at least in part on a set of initial (e.g., previous) uplink traffic bursts from the application client 510, that are transmitted by the UE 120 in uplink communications to the base station 110. For example, the application client 510 may determine the uplink traffic features based at least in part on a certain number of initial uplink traffic transmissions and/or uplink traffic transmissions within a certain time duration. In some aspects, the application client 510 may determine the uplink traffic features based at least in part on uplink burst arrival times that are independent of any wireless network (e.g., 5G) scheduling times. In some aspects, the application client 510 may translate an application layer timing for the uplink traffic to a wireless network (e.g., 5G) timing.

In some aspects, the UE 120 may detect the uplink traffic features associated with the uplink traffic from the application client 510 without receiving the uplink traffic features from the application client 510 via the cross-layer API. In this case, the UE 120 may learn the uplink traffic features from a set of uplink transmissions of traffic from the application client 510 to the base station 110.

As further shown in FIG. 6, and by reference number 610, the UE 120 may determine recommended CDRX parameters based at least in part on the uplink traffic features associated with the uplink traffic from the application client 510. In some aspects, the UE 120 may identify uplink and downlink transmission opportunities based at least in part on the uplink traffic features associated with the uplink traffic from the application client 510. In some aspects, the UE 120 may determine the transmission opportunities to align the transmission opportunities with the uplink transmissions of traffic from the application client 510 based at least in part on the uplink traffic features. For example, the timing of the transmission opportunities may correspond to a timing (e.g., periodicity) of the uplink traffic, and the duration of each of the transmission opportunities may be long enough to allow for a burst of uplink traffic from the application client 510 to be transmitted by the UE 120 and for a burst of downlink traffic from the application server 505, to be transmitted by the base station 110 and received by the UE 120.

In some aspects, as shown in FIG. 6, the transmission opportunities may include CDRX ON times of a CDRX cycle configured for the UE 120. In this case, the UE 120 may determine recommended CDRX parameters to configure the CDRX ON times for the UE 120 to be aligned with expected uplink transmissions of traffic from the application client 510. For example, the UE 120 may determine recommended CDRX parameters that set the timing of the CDRX ON times to correspond with the timing for the uplink transmissions (e.g., uplink arrivals from the application client 510), and set the duration of the CDRX ON times to allow time for the expected uplink transmissions, as well as the downlink transmissions of traffic from the application server 505, during the CDRX ON times.

As further shown in FIG. 6, and by reference number 615, the UE 120 may transmit, to the base station 110, the recommended CDRX parameters associated with the transmission opportunities (e.g., CDRX ON times) determined by the UE 120. In some aspects, the UE 120 may transmit, to the base station 110, information that identifies the uplink and downlink transmission opportunities that are based at least in part on the uplink features of the uplink traffic from the application client 510. In some aspects, as shown in FIG. 6, the base station 110 may transmit the recommended CDRX parameters that indicate CDRX ON times that are aligned with the uplink transmissions of traffic from the application client 510. For example, the UE 120 may transmit the recommended CDRX parameters to the base station 110 via a UE assistance RRC message. In this case, the UE assistance RRC message may include a parameter set (e.g., drx-StartOffset) for indicating the CDRX parameters recommended by the UE 120. In some aspects, the base station 110 may set the CDRX parameters for the CDRX configuration for the UE 120 based at least in part on the recommended CDRX parameters received from the UE 120. For example, the base station 110 may transmit, to the UE 120, an RRC configuration for the CDRX configuration that includes updated CDRX parameters corresponding to the recommended CDRX parameters.

In some aspects, instead of or in addition to the recommended CDRX parameters, the information that identifies the transmission opportunities aligned with the uplink transmissions may include the uplink traffic features associated with the uplink traffic from the application client 510. In this case, the UE 120 may transmit, to the base station 110, the uplink traffic features received from the application client 510 or learned by the UE 120. In some aspects, the base station 110 may detect the uplink traffic features associated with the uplink traffic based at least in part on uplink transmissions including the uplink traffic. For example, the base station 110 may learn the uplink traffic features from a set of uplink transmissions, transmitted to the base station 110 from UE 120, that include the uplink traffic from the application client 510. In some aspects, the base station 110 may receive the uplink features from the application server 505. For example, the application server 505 may determine the uplink traffic features based on uplink traffic, from the application client 510, received by the application server 505, and the application server 505 may send the uplink traffic features to the base station 110 via the NEF API.

In some aspects, the base station 110 may identify transmission opportunities aligned with the uplink transmissions based at least in part on the information (e.g., uplink traffic features and/or recommended CDRX parameters) received from the UE 120 or based at least in part on the uplink traffic features learned by the base station 110 or received from the application server 505. In some aspects, the base station 110 may plan transitions for the UE 120 to a first BWP during the transmission opportunities (e.g., during times associated with the uplink transmissions) and to a second BWP during gaps between the transmission opportunities aligned with the uplink transmissions. In this case, the second BWP may be associated with a lower power consumption than the first BWP. For example, the first BWP may be a high-throughput BWP and the second BWP may be a low-power BWP. The base station 110 may transmit, to the UE 120 indications (e.g., in DCI) for the UE 120 to switch to the first BWP during the transmission opportunities and to the second BWP between the transmission opportunities.

In some aspects, the transmission opportunities may include times associated with periodic uplink grants and/or uplink configured grants (UL-CGs). For example, the base station 110 may schedule periodic uplink grants and/or UL-CGs for the UE 120 during the transmission opportunities determined based at least in part on the uplink traffic features. In some aspects, the base station 110 may schedule periodic uplink grants and/or UL-CGs for the UE 120 during a configured CDRX ON time and/or a time at which the UE 120 is switched to the first BWP (e.g., the high throughput BWP).

As further shown in FIG. 6, and by reference number 620, the base station 110 may transmit an indication of the uplink and downlink transmission opportunities (e.g., the CDRX ON times) to the application server 505 via the NEF API. For example, the NEF API may allow information to be shared between the application server 505 and the base station 110. In some aspects, as shown in FIG. 6, the base station 110 may expose to the application server 505, via the NEF API, the CDRX ON times (and/or other CDRX parameters) determined based at least in part on the uplink traffic from the application client 510. For example, the UE 120 may communicate to the application client 510, via the NEF API, the CDRX ON times that are aligned with the uplink communications including the uplink traffic from the application client 510.

In some aspects, instead of or in addition to the CDRX ON times, the base station 110 may expose and/or communicate to the application server 505, via the NEF API, predicted times at which the base station 110 will send indications to the UE 120 to switch to the first BWP (e.g., the high throughput BWP) from the second BWP (e.g., the low-power BWP). For example, the predicted times may correspond to the transmission opportunities determined based at least in part on the uplink traffic features associated with the uplink traffic from the application client 510.

In some aspects, the base station 110 may expose and/or communicate to the application client 510, via the NEF API, transmission opportunities that include times associated with a scheduled periodic uplink grant. In some aspects, the base station 110 may expose and/or communicate to the application client 510, via the NEF API, transmission opportunities that include times associated with one or more scheduled UL-CGs.

As further shown in FIG. 6, and by reference number 625, the application server 505 may alter downlink burst arrival times (t5_DL_A(n)) to match the uplink and downlink transmission opportunities (e.g., the CDRX ON times). For example, the application server 505 may alter the arrival times of downlink traffic from the application server 505 such that arrival times, at which the application server 505 introduces/outputs the downlink traffic to a buffer of the base station 110, match the transmission opportunities. In some aspects, as shown in FIG. 6, the application server 505 may adjust the arrival times for the uplink traffic to output the uplink traffic during the CDRX ON times (e.g., the CDRX ON times that are aligned with the uplink transmissions of the traffic from the application client 510).

In some aspects, the application server 505 may alter the arrival times for the downlink traffic to match the predicted times at which the base station 110 will transmit indications to the UE 120 to switch to the first BWP (e.g., the high-throughput BWP). In some aspects, the application server 505 may alter the arrival times for the downlink traffic to be aligned with (e.g., in proximity with in the time domain) times associated with scheduled periodic uplink grants (e.g., periodic uplink grants that are scheduled for the uplink transmissions of traffic from the application client 510). In some aspects, the application server 505 may alter the arrival times for the downlink traffic to be aligned with times associated with one or more scheduled UL-CGs (e.g., one or more UL-CGs that are scheduled for the uplink transmissions of traffic from the application client 510).

As further shown in FIG. 6, and by reference number 630, the UE 120 may receive uplink burst traffic from the application client 510, and the UE 120 may transmit, to the base station 110, uplink communications including the uplink burst traffic. The base station 110 may receive the uplink communications from the UE 120 and convey the uplink data included in the uplink communications to the application server 505. As shown by reference number 635, the base station 110 may receive downlink burst traffic from the application server 505, and the base station 110 may transmit, to the UE 120, downlink communications including the downlink burst traffic. The UE 120 may receive the downlink communications from the base station 110 and convey the downlink data included in the downlink communications to the application client 510. In some aspects, the uplink burst traffic and the downlink burst traffic may be transmitted in the uplink and downlink transmission opportunities that are determined based at least in part on the uplink traffic features. This may result in the uplink transmissions and downlink transmission being aligned (or grouped) in close proximity to each other, in the time domain, with gaps between the grouped uplink and downlink transmissions.

As described above in connection with FIG. 6, the UE 120 may transmit, to the base station 110, information identifying uplink and downlink transmission opportunities that are based at least in part on uplink traffic from the application client 510. The base station 110 may communicate the transmission opportunities to an application server 505 via an NEF API, which may cause the application server 505 to alter arrival times of downlink traffic to match the transmission opportunities. The base station 110 may transmit, to the UE 120, downlink communications including the downlink traffic from the application server 505 in the transmission opportunities. As a result, the downlink transmissions may be aligned or grouped with the uplink transmissions, resulting in larger gaps between the groupings of uplink and downlink transmissions. This may allow the UE 120 to enter a sleep state (e.g., CDRX OFF) during such gaps, and therefore may reduce power consumption of the UE 120 without increased latency due to increased buffering of the uplink communications.

As indicated above, FIG. 6 is provided as an example. Other examples may differ from what is described with respect to FIG. 6.

FIG. 7 is a diagram illustrating an example 700 associated with uplink and downlink traffic alignment for power savings, in accordance with the present disclosure. As shown in FIG. 7, example 700 shows exemplary power saving results for different configurations of a split rendering XR system due to uplink and downlink traffic alignment, as described elsewhere herein. For each configuration, example 700 shows the power savings resulting from light-sleep and deep-sleep for a high signal-to-noise ratio (SNR) and a low SNR, as compared to the same configuration without uplink and downlink traffic alignment. Light-sleep and deep-sleep are different levels of sleep with different times to transition in and out of sleep. In example 700, “NA” means “not applicable” (e.g., the sleep state was not achieved), and “MP” means “made possible,” which corresponds to a situation in which a sleep state that was not possible without uplink and downlink traffic alignment is made possible by uplink and downlink traffic alignment. The power savings resulting from “MP” for the deep-sleep state, as compared to no sleep, are greater than 50%.

As indicated above, FIG. 7 is provided as an example. Other examples may differ from what is described with respect to FIG. 7.

FIG. 8 is a diagram illustrating an example process 800 performed, for example, by a UE, in accordance with the present disclosure. Example process 800 is an example where the UE (e.g., UE 120) performs operations associated with uplink and downlink traffic alignment for power savings.

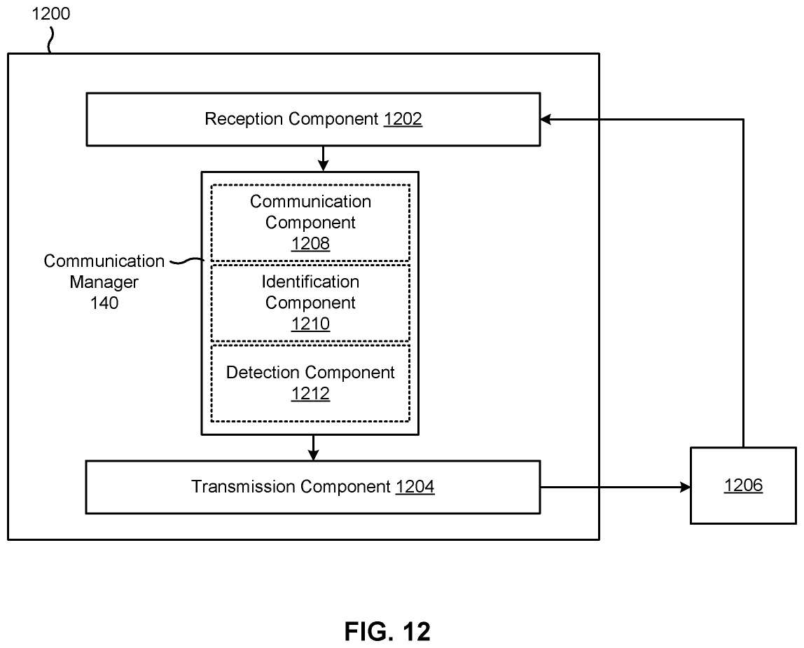

As shown in FIG. 8, in some aspects, process 800 may include receiving, from a base station, information identifying uplink and downlink transmission opportunities that are based at least in part on downlink traffic from an application server (block 810). For example, the UE (e.g., using communication manager 140 and/or reception component 1202, depicted in FIG. 12) may receive, from a base station, information identifying uplink and downlink transmission opportunities that are based at least in part on downlink traffic from an application server, as described above.

As further shown in FIG. 8, in some aspects, process 800 may include communicating the uplink and downlink transmission opportunities to an application client connected to the UE via a cross-layer API (block 820). For example, the UE (e.g., using communication manager 140 and/or communication component 1208, depicted in FIG. 12) may communicate the uplink and downlink transmission opportunities to an application client connected to the UE via a cross-layer API, as described above.

As further shown in FIG. 8, in some aspects, process 800 may include transmitting one or more uplink communications including traffic from the application client in one or more of the uplink and downlink transmission opportunities (block 830). For example, the UE (e.g., using communication manager 140 and/or transmission component 1204, depicted in FIG. 12) may transmit one or more uplink communications including traffic from the application client in one or more of the uplink and downlink transmission opportunities, as described above.

Process 800 may include additional aspects, such as any single aspect or any combination of aspects described below and/or in connection with one or more other processes described elsewhere herein.

In a first aspect, the traffic from the application client is output from the application client during the uplink and downlink transmission opportunities.

In a second aspect, alone or in combination with the first aspect, the application client alters arrival times of the traffic from the application client in a buffer of the UE to match the uplink and downlink transmission opportunities.

In a third aspect, alone or in combination with one or more of the first and second aspects, the uplink and downlink transmission opportunities include CDRX ON times that are aligned with transmissions of the downlink traffic from the application server.

In a fourth aspect, alone or in combination with one or more of the first through third aspects, receiving the information identifying the uplink and downlink transmission opportunities includes receiving an indication of one or more CDRX parameters that identify the CDRX ON times that are aligned with the transmissions of the downlink traffic from the application server.

In a fifth aspect, alone or in combination with one or more of the first through fourth aspects, the information includes indications for the UE to switch between a first BWP for times associated with transmissions of the downlink traffic from the application server and a second BWP during gaps between the transmissions of the downlink traffic from the application server, and the second BWP is associated with a lower power consumption than the first BWP.

In a sixth aspect, alone or in combination with one or more of the first through fifth aspects, receiving the information identifying the uplink and downlink transmission opportunities includes receiving downlink control information including the indications to switch between the first BWP and the second BWP.

In a seventh aspect, alone or in combination with one or more of the first through sixth aspects, process 800 includes identifying the transmission opportunities based at least in part on a BWP switching pattern determined from the indications to switch between the first BWP and the second BWP, and the transmission opportunities include predicted times at which the UE will switch to the first BWP.

In an eighth aspect, alone or in combination with one or more of the first through seventh aspects, the transmission opportunities include times associated with a periodic uplink grant aligned with the downlink transmissions of the traffic from the application server.

In a ninth aspect, alone or in combination with one or more of the first through eighth aspects, the transmission opportunities include one or more times associated with one or more uplink configured grants that are aligned with one or more of the downlink transmissions of the traffic from the application server.

In a tenth aspect, alone or in combination with one or more of the first through ninth aspects, the application client is a virtual reality or augmented reality application client, and the application server is a virtual reality or augmented reality application server.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a base station, in accordance with the present disclosure. Example process 900 is an example where the base station (e.g., base station 110) performs operations associated with uplink and downlink traffic alignment for power savings.

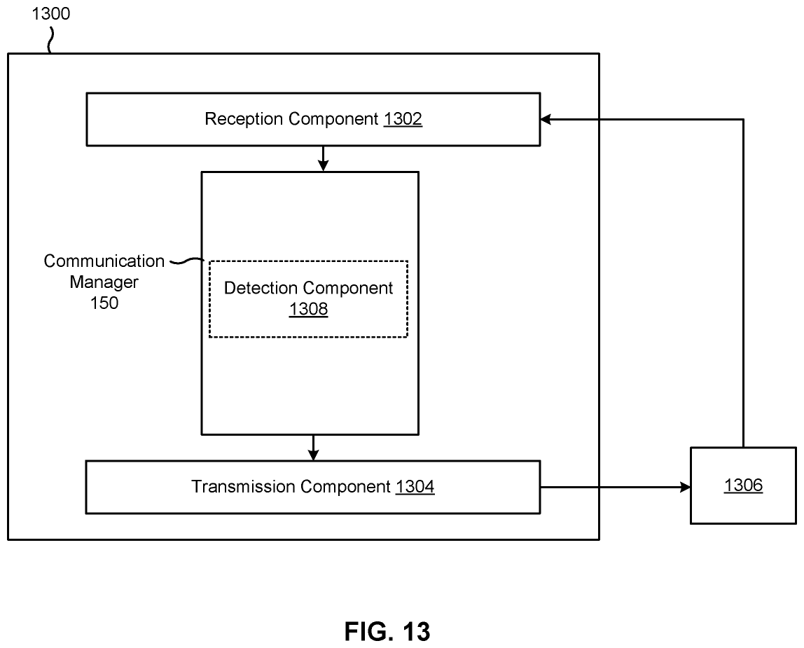

As shown in FIG. 9, in some aspects, process 900 may include transmitting, to a UE, downlink transmissions including traffic from an application server (block 910). For example, the base station (e.g., using communication manager 150 and/or transmission component 1304, depicted in FIG. 13) may transmit, to a UE, downlink transmissions including traffic from an application server, as described above.

As further shown in FIG. 9, in some aspects, process 900 may include transmitting, to the UE, information identifying uplink and downlink transmission opportunities that are based at least in part on the downlink transmissions including the traffic from the application server (block 920). For example, the base station (e.g., using communication manager 150 and/or transmission component 1304, depicted in FIG. 13) may transmit, to the UE, information identifying uplink and downlink transmission opportunities that are based at least in part on the downlink transmissions including the traffic from the application server, as described above.

Process 900 may include additional aspects, such as any single aspect or any combination of aspects described below and/or in connection with one or more other processes described elsewhere herein.

In a first aspect, process 900 includes receiving, from the application server, downlink traffic features associated with the traffic from the application server, and the uplink and downlink transmission opportunities are determined based at least in part on the downlink traffic features.

In a second aspect, alone or in combination with the first aspect, the downlink traffic features include at least one of a periodicity associated with the traffic from the application server, a jitter associated with the traffic from the application server, a time duration associated with the traffic from the application server, or a burst arrival offset associated with the traffic from the application server.

In a third aspect, alone or in combination with one or more of the first and second aspects, process 900 includes detecting downlink traffic features associated with the traffic from the application server, and the uplink and downlink transmission opportunities are determined based at least in part on the downlink traffic features.

In a fourth aspect, alone or in combination with one or more of the first through third aspects, the uplink and downlink transmission opportunities include CDRX ON times that are aligned with the downlink transmissions of the traffic from the application server.

In a fifth aspect, alone or in combination with one or more of the first through fourth aspects, transmitting the information identifying the uplink and downlink transmission opportunities includes transmitting an indication of one or more CDRX parameters that identify the CDRX ON times that are aligned with the downlink transmissions of the traffic from the application server.

In a sixth aspect, alone or in combination with one or more of the first through fifth aspects, the information includes indications for the UE to switch between a first BWP for times associated with the downlink transmissions of the traffic from the application server and a second BWP during gaps between the downlink transmissions of the traffic from the application server, and the second BWP is associated with a lower power consumption than the first BWP.

In a seventh aspect, alone or in combination with one or more of the first through sixth aspects, transmitting the information identifying the uplink and downlink transmission opportunities includes transmitting downlink control information including the indications to switch between the first BWP and the second BWP.

In an eighth aspect, alone or in combination with one or more of the first through seventh aspects, the transmission opportunities include times associated with a periodic uplink grant aligned with the downlink transmissions of the traffic from the application server.

In a ninth aspect, alone or in combination with one or more of the first through eighth aspects, the transmission opportunities include one or more times associated with one or more uplink configured grants that are aligned with one or more of the downlink transmissions of the traffic from the application server.

In a tenth aspect, alone or in combination with one or more of the first through ninth aspects, the application client is a virtual reality or augmented reality application client, and the application server is a virtual reality or augmented reality application server.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a UE, in accordance with the present disclosure. Example process 1000 is an example where the UE (e.g., UE 120) performs operations associated with uplink and downlink traffic alignment for power savings.

As shown in FIG. 10, in some aspects, process 1000 may include transmitting, to a base station, uplink transmissions including traffic from an application client connected to the UE (block 1010). For example, the UE (e.g., using communication manager 140 and/or transmission component 1204, depicted in FIG. 12) may transmit, to a base station, uplink transmissions including traffic from an application client connected to the UE, as described above.

As further shown in FIG. 10, in some aspects, process 1000 may include transmitting, to the base station, information identifying uplink and downlink transmission opportunities that are based at least in part on the uplink transmissions including the traffic from the application client (block 1020). For example, the UE (e.g., using communication manager 140 and/or transmission component 1204, depicted in FIG. 12) may transmit, to the base station, information identifying uplink and downlink transmission opportunities that are based at least in part on the uplink transmissions including the traffic from the application client, as described above.

Process 1000 may include additional aspects, such as any single aspect or any combination of aspects described below and/or in connection with one or more other processes described elsewhere herein.

In a first aspect, process 1000 includes receiving, from the application client and via a cross-layer API, uplink traffic features associated with the traffic from the application client, and the uplink and downlink transmission opportunities are determined based at least in part on the uplink traffic features.

In a second aspect, alone or in combination with the first aspect, process 1000 includes detecting uplink traffic features associated with the traffic from the application client, and the uplink and downlink transmission opportunities are determined based at least in part on the uplink traffic features.

In a third aspect, alone or in combination with one or more of the first and second aspects, the uplink and downlink transmission opportunities include CDRX ON times that are aligned with the uplink transmissions of the traffic from the application client, and the information includes an indication of recommended CDRX parameters that identify the CDRX ON times that are aligned with the uplink transmissions of the traffic from the application client.

In a fourth aspect, alone or in combination with one or more of the first through third aspects, transmitting the information identifying the uplink and downlink transmission opportunities includes transmitting, to the base station, a radio resource control message including the indication of the recommended CDRX parameters.

In a fifth aspect, alone or in combination with one or more of the first through fourth aspects, process 1000 includes receiving, from the base station, one or more downlink communications including traffic from an application server during one or more of the downlink transmission opportunities.

In a sixth aspect, alone or in combination with one or more of the first through fifth aspects, transmitting the information identifying the uplink and downlink transmission opportunities includes transmitting, to the base station, uplink traffic features associated with the traffic from the application client.

In a seventh aspect, alone or in combination with one or more of the first through sixth aspects, the application client is a virtual reality or augmented reality application client.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

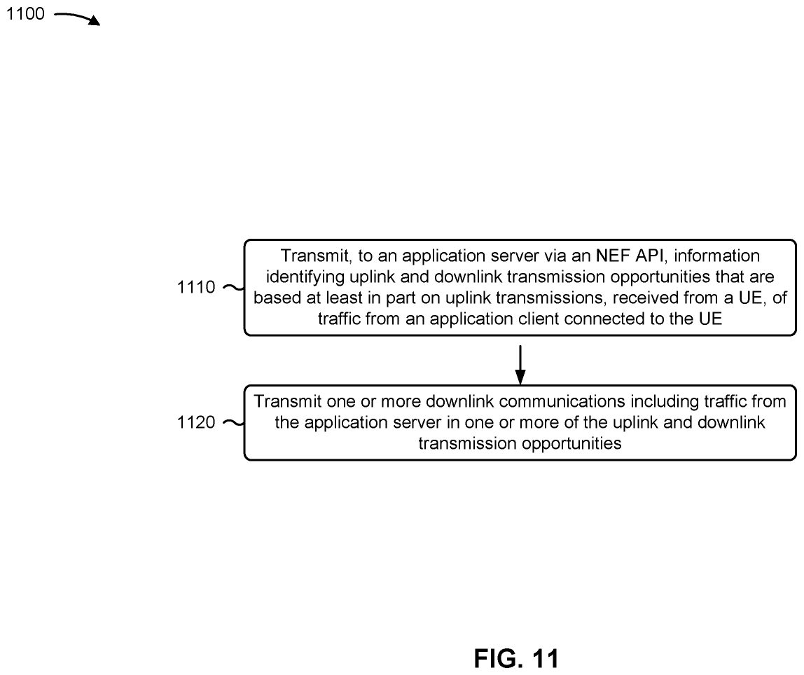

FIG. 11 is a diagram illustrating an example process 1100 performed, for example, by a base station, in accordance with the present disclosure. Example process 1100 is an example where the base station (e.g., base station 110) performs operations associated with uplink and downlink traffic alignment for power savings.

As shown in FIG. 11, in some aspects, process 1100 may include transmitting, to an application server via an NEF API, information identifying uplink and downlink transmission opportunities based at least in part on uplink transmissions, received from a UE, of traffic from an application client connected to the UE (block 1110). For example, the base station (e.g., using communication manager 150 and/or transmission component 1304, depicted in FIG. 13) may transmit, to an application server via an NEF API, information identifying uplink and downlink transmission opportunities based at least in part on uplink transmissions, received from a UE, of traffic from an application client connected to the UE, as described above.

As further shown in FIG. 11, in some aspects, process 1100 may include transmitting, to the UE, one or more downlink communications including traffic from the application server in one or more of the uplink and downlink transmission opportunities (block 1120). For example, the base station (e.g., using communication manager 150 and/or transmission component 1304, depicted in FIG. 13) may transmit, to the UE, one or more downlink communications including traffic from the application server in one or more of the uplink and downlink transmission opportunities, as described above.

Process 1100 may include additional aspects, such as any single aspect or any combination of aspects described below and/or in connection with one or more other processes described elsewhere herein.

In a first aspect, the uplink and downlink transmission opportunities include CDRX ON times that are aligned with the uplink transmissions, and process 1100 includes receiving, from the UE, an indication of recommended CDRX parameters that identify the CDRX ON times that are aligned with the uplink transmissions of the traffic from the application client.

In a second aspect, alone or in combination with the first aspect, process 1100 includes receiving, from the UE, uplink traffic features associated with the uplink transmissions received from the UE, and the uplink and downlink transmission opportunities are determined based at least in part on the uplink traffic features.

In a third aspect, alone or in combination with one or more of the first and second aspects, process 1100 includes detecting uplink traffic features associated with the uplink transmissions received from the UE, and the uplink and downlink transmission opportunities are determined based at least in part on the uplink traffic features.

In a fourth aspect, alone or in combination with one or more of the first through third aspects, process 1100 includes receiving, from the application server, uplink traffic features associated with the uplink transmissions received from the UE, and the uplink and downlink transmission opportunities are determined based at least in part on the uplink traffic features.

In a fifth aspect, alone or in combination with one or more of the first through fourth aspects, the application client is a virtual reality or augmented reality application client, and the application server is a virtual reality or augmented reality application server.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a block diagram of an example apparatus 1200 for wireless communication. The apparatus 1200 may be a UE, or a UE may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204. As further shown, the apparatus 1200 may include the communication manager 140. The communication manager 140 may include one or more of a communication component 1208, an identification component 1210, or a detection component 1212, among other examples.

In some aspects, the apparatus 1200 may be configured to perform one or more operations described herein in connection with FIGS. 5-7. Additionally, or alternatively, the apparatus 1200 may be configured to perform one or more processes described herein, such as process 800 of FIG. 8, process 1000 of FIG. 10, or a combination thereof. In some aspects, the apparatus 1200 and/or one or more components shown in FIG. 12 may include one or more components of the UE described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1206. In some aspects, the reception component 1202 may include one or more antennas, a demodulator, a MIMO detector, a receive processor, a controller/processor, a memory, or a combination thereof, of the UE described in connection with FIG. 2.

The transmission component 1204 may transmit communications, such as reference signals, control information, data communications, or a combination thereof, to the apparatus 1206. In some aspects, one or more other components of the apparatus 1206 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modulator, a transmit MIMO processor, a transmit processor, a controller/processor, a memory, or a combination thereof, of the UE described in connection with FIG. 2. In some aspects, the transmission component 1204 may be co-located with the reception component 1202 in a transceiver.

The reception component 1202 may receive, from a base station, information identifying uplink and downlink transmission opportunities that are based at least in part on downlink traffic from an application server. The communication component 1208 may communicate the uplink and downlink transmission opportunities to an application client connected to the UE via a cross-layer API. The transmission component 1204 may transmit one or more uplink communications including traffic from the application client in one or more of the uplink and downlink transmission opportunities.

The identification component 1210 may identify the transmission opportunities based at least in part on a BWP switching pattern determined from the indications to switch between the first BWP and the second BWP, wherein the transmission opportunities include predicted times at which the UE will switch to the first BWP.

The transmission component 1204 may transmit, to a base station, uplink transmissions including traffic from an application client connected to the UE. The transmission component 1204 may transmit, to the base station, information identifying uplink and downlink transmission opportunities that are based at least in part on the uplink transmissions including the traffic from the application client.

The communication component 1208 may receive, from the application client and via a cross-layer API, uplink traffic features associated with the traffic from the application client, wherein the uplink and downlink transmission opportunities are determined based at least in part on the uplink traffic features.

The detection component 1212 may detect uplink traffic features associated with the traffic from the application client, wherein the uplink and downlink transmission opportunities are determined based at least in part on the uplink traffic features.

The reception component 1202 may receive, from the base station, one or more downlink communications including traffic from an application server during one or more of the downlink transmission opportunities.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

FIG. 13 is a block diagram of an example apparatus 1300 for wireless communication. The apparatus 1300 may be a base station, or a base station may include the apparatus 1300. In some aspects, the apparatus 1300 includes a reception component 1302 and a transmission component 1304, which may be in communication with one another (for example, via one or more buses and/or one or more other components). As shown, the apparatus 1300 may communicate with another apparatus 1306 (such as a UE, a base station, or another wireless communication device) using the reception component 1302 and the transmission component 1304. As further shown, the apparatus 1300 may include the communication manager 150. The communication manager 150 may include a detection component 1308, among other examples.

In some aspects, the apparatus 1300 may be configured to perform one or more operations described herein in connection with FIGS. 5-7. Additionally, or alternatively, the apparatus 1300 may be configured to perform one or more processes described herein, such as process 900 of FIG. 9, process 1100 of FIG. 11, or a combination thereof. In some aspects, the apparatus 1300 and/or one or more components shown in FIG. 13 may include one or more components of the base station described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1306. In some aspects, the reception component 1302 may include one or more antennas, a demodulator, a MIMO detector, a receive processor, a controller/processor, a memory, or a combination thereof, of the base station described in connection with FIG. 2.

The transmission component 1304 may transmit communications, such as reference signals, control information, data communications, or a combination thereof, to the apparatus 1306. In some aspects, one or more other components of the apparatus 1306 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modulator, a transmit MIMO processor, a transmit processor, a controller/processor, a memory, or a combination thereof, of the base station described in connection with FIG. 2. In some aspects, the transmission component 1304 may be co-located with the reception component 1302 in a transceiver.

The transmission component 1304 may transmit, to a UE, downlink transmissions including traffic from an application server. The transmission component 1304 may transmit, to the UE, information identifying uplink and downlink transmission opportunities that are based at least in part on the downlink transmissions including the traffic from the application server.

The reception component 1302 may receive, from the application server, downlink traffic features associated with the traffic from the application server, wherein the uplink and downlink transmission opportunities are determined based at least in part on the downlink traffic features.

The detection component 1308 may detect downlink traffic features associated with the traffic from the application server, wherein the uplink and downlink transmission opportunities are determined based at least in part on the downlink traffic features.

The transmission component 1304 may transmit, to an application server via an NEF API, information identifying uplink and downlink transmission opportunities based at least in part on uplink transmissions, received from a UE, of traffic from an application client connected to the UE. The transmission component 1304 may transmit, to the UE, one or more downlink communications including traffic from the application server in one or more of the uplink and downlink transmission opportunities.

The reception component 1302 may receive, from the UE, uplink traffic features associated with the uplink transmissions received from the UE, wherein the uplink and downlink transmission opportunities are determined based at least in part on the uplink traffic features.

The detection component 1308 may detect uplink traffic features associated with the uplink transmissions received from the UE, wherein the uplink and downlink transmission opportunities are determined based at least in part on the uplink traffic features.

The reception component 1302 may receive, from the application server, uplink traffic features associated with the uplink transmissions received from the UE, wherein the uplink and downlink transmission opportunities are determined based at least in part on the uplink traffic features.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

The following provides an overview of some Aspects of the present disclosure:

Aspect 1: A method of wireless communication performed by a user equipment (UE), comprising: receiving, from a base station, information identifying uplink and downlink transmission opportunities that are based at least in part on downlink traffic from an application server; communicating the uplink and downlink transmission opportunities to an application client connected to the UE via a cross-layer application programming interface (API); and transmitting one or more uplink communications including traffic from the application client in one or more of the uplink and downlink transmission opportunities.

Aspect 2: The method of Aspect 1, wherein the traffic from the application client is output from the application client during the uplink and downlink transmission opportunities.

Aspect 3: The method of any of Aspects 1-2, wherein the application client alters arrival times of the traffic from the application client in a buffer of the UE to match the uplink and downlink transmission opportunities.

Aspect 4: The method of any of Aspects 1-3, wherein the uplink and downlink transmission opportunities include connected mode discontinuous reception (CDRX) ON times that are aligned with transmissions of the downlink traffic from the application server.

Aspect 5: The method of Aspect 4, wherein receiving the information identifying the uplink and downlink transmission opportunities comprises: receiving an indication of one or more CDRX parameters that identify the CDRX ON times that are aligned with the transmissions of the downlink traffic from the application server.

Aspect 6: The method of any of Aspects 1-3, wherein the information includes indications for the UE to switch between a first bandwidth part (BWP) for times associated with transmissions of the downlink traffic from the application server and a second BWP during gaps between the transmissions of the downlink traffic from the application server, and wherein the second BWP is associated with a lower power consumption than the first BWP.

Aspect 7: The method of Aspect 6, wherein receiving the information identifying the uplink and downlink transmission opportunities comprises: receiving downlink control information including the indications to switch between the first BWP and the second BWP.

Aspect 8: The method of any of Aspects 6-7, further comprising: identifying the transmission opportunities based at least in part on a BWP switching pattern determined from the indications to switch between the first BWP and the second BWP, wherein the transmission opportunities include predicted times at which the UE will switch to the first BWP.

Aspect 9: The method of any of Aspects 1-8, wherein the transmission opportunities include times associated with a periodic uplink grant aligned with the downlink transmissions of the traffic from the application server.

Aspect 10: The method of any of Aspects 1-9, wherein the transmission opportunities include one or more times associated with one or more uplink configured grants that are aligned with one or more of the downlink transmissions of the traffic from the application server.

Aspect 11: The method of any of Aspects 1-10, wherein the application client is a virtual reality or augmented reality application client, and wherein the application server is a virtual reality or augmented reality application server.

Aspect 12: A method of wireless communication performed by a base station, comprising: transmitting, to a user equipment (UE), downlink transmissions including traffic from an application server; and transmitting, to the UE, information identifying uplink and downlink transmission opportunities that are based at least in part on the downlink transmissions including the traffic from the application server.

Aspect 13: The method of Aspect 12, further comprising: receiving, from the application server, downlink traffic features associated with the traffic from the application server, wherein the uplink and downlink transmission opportunities are determined based at least in part on the downlink traffic features.

Aspect 14: The method of Aspect 13, wherein the downlink traffic features include at least one of a periodicity associated with the traffic from the application server, a jitter associated with the traffic from the application server, a time duration associated with the traffic from the application server, or a burst arrival offset associated with the traffic from the application server.

Aspect 15: The method of Aspect 12, further comprising: detecting downlink traffic features associated with the traffic from the application server, wherein the uplink and downlink transmission opportunities are determined based at least in part on the downlink traffic features.

Aspect 16: The method of any of Aspects 12-15, wherein the uplink and downlink transmission opportunities include connected mode discontinuous reception (CDRX) ON times that are aligned with the downlink transmissions of the traffic from the application server.

Aspect 17: The method of Aspect 16, wherein transmitting the information identifying the uplink and downlink transmission opportunities comprises: transmitting an indication of one or more CDRX parameters that identify the CDRX ON times that are aligned with the downlink transmissions of the traffic from the application server.

Aspect 18: The method of any of Aspects 12-15, wherein the information includes indications for the UE to switch between a first bandwidth part (BWP) for times associated with the downlink transmissions of the traffic from the application server and a second BWP during gaps between the downlink transmissions of the traffic from the application server, and wherein the second BWP is associated with a lower power consumption than the first BWP.

Aspect 19: The method of Aspect 18, wherein transmitting the information identifying the uplink and downlink transmission opportunities comprises: transmitting downlink control information including the indications to switch between the first BWP and the second BWP.

Aspect 20: The method of any of Aspects 12-19, wherein the transmission opportunities include times associated with a periodic uplink grant aligned with the downlink transmissions of the traffic from the application server.

Aspect 21: The method of any of Aspects 12-20, wherein the transmission opportunities include one or more times associated with one or more uplink configured grants that are aligned with one or more of the downlink transmissions of the traffic from the application server.

Aspect 22: The method of any of Aspects 12-21, wherein the application client is a virtual reality or augmented reality application client, and wherein the application server is a virtual reality or augmented reality application server.

Aspect 23: A method of wireless communication performed by a user equipment (UE), comprising: transmitting, to a base station, uplink transmissions including traffic from an application client connected to the UE; and transmitting, to the base station, information identifying uplink and downlink transmission opportunities that are based at least in part on the uplink transmissions including the traffic from the application client.

Aspect 24: The method of Aspect 23, further comprising: receiving, from the application client and via a cross-layer application programming interface (API), uplink traffic features associated with the traffic from the application client, wherein the uplink and downlink transmission opportunities are determined based at least in part on the uplink traffic features.

Aspect 25: The method of Aspect 23, further comprising: detecting uplink traffic features associated with the traffic from the application client, wherein the uplink and downlink transmission opportunities are determined based at least in part on the uplink traffic features.

Aspect 26: The method of any of Aspects 23-25, wherein the uplink and downlink transmission opportunities include connected mode discontinuous reception (CDRX) ON times that are aligned with the uplink transmissions of the traffic from the application client, and wherein the information includes an indication of recommended CDRX parameters that identify the CDRX ON times that are aligned with the uplink transmissions of the traffic from the application client.

Aspect 27: The method of Aspect 26, wherein transmitting the information identifying the uplink and downlink transmission opportunities comprises: transmitting, to the base station, a radio resource control message including the indication of the recommended CDRX parameters.

Aspect 28: The method of any of Aspects 23-27, further comprising: receiving, from the base station, one or more downlink communications including traffic from an application server during one or more of the downlink transmission opportunities.

Aspect 29: The method of any of Aspects 23-28, wherein transmitting the information identifying the uplink and downlink transmission opportunities comprises: transmitting, to the base station, uplink traffic features associated with the traffic from the application client.

Aspect 30: The method of any of Aspects 23-29, wherein the application client is a virtual reality or augmented reality application client.

Aspect 31: A method of wireless communication performed by base station, comprising: transmitting, to an application server via a network exposure function (NEF) application programming interface (API), information identifying uplink and downlink transmission opportunities based at least in part on uplink transmissions, received from a user equipment (UE), of traffic from an application client connected to the UE; and transmitting, to the UE, one or more downlink communications including traffic from the application server in one or more of the uplink and downlink transmission opportunities.

Aspect 32: The method of Aspect 31, wherein the uplink and downlink transmission opportunities include connected mode discontinuous reception (CDRX) ON times that are aligned with the uplink transmissions, and the method further comprises: receiving, from the UE, an indication of recommended CDRX parameters that identify the CDRX ON times that are aligned with the uplink transmissions of the traffic from the application client.

Aspect 33: The method of Aspect 31, further comprising: receiving, from the UE, uplink traffic features associated with the uplink transmissions received from the UE, wherein the uplink and downlink transmission opportunities are determined based at least in part on the uplink traffic features.

Aspect 34: The method of Aspect 31, further comprising: detecting uplink traffic features associated with the uplink transmissions received from the UE, wherein the uplink and downlink transmission opportunities are determined based at least in part on the uplink traffic features.

Aspect 35: The method of Aspect 31, further comprising: receiving, from the application server, uplink traffic features associated with the uplink transmissions received from the UE, wherein the uplink and downlink transmission opportunities are determined based at least in part on the uplink traffic features.

Aspect 36: The method of any of Aspects 31-35, wherein the application client is a virtual reality or augmented reality application client, and wherein the application server is a virtual reality or augmented reality application server.

Aspect 37: An apparatus for wireless communication at a device, comprising a processor; memory coupled with the processor; and instructions stored in the memory and executable by the processor to cause the apparatus to perform the method of one or more of Aspects 1-11.

Aspect 38: An apparatus for wireless communication at a device, comprising a processor; memory coupled with the processor; and instructions stored in the memory and executable by the processor to cause the apparatus to perform the method of one or more of Aspects 12-22.

Aspect 39: An apparatus for wireless communication at a device, comprising a processor; memory coupled with the processor; and instructions stored in the memory and executable by the processor to cause the apparatus to perform the method of one or more of Aspects 23-30.

Aspect 40: An apparatus for wireless communication at a device, comprising a processor; memory coupled with the processor; and instructions stored in the memory and executable by the processor to cause the apparatus to perform the method of one or more of Aspects 31-36.

Aspect 41: A device for wireless communication, comprising a memory and one or more processors coupled to the memory, the one or more processors configured to perform the method of one or more of Aspects 1-11.

Aspect 42: A device for wireless communication, comprising a memory and one or more processors coupled to the memory, the one or more processors configured to perform the method of one or more of Aspects 12-22.

Aspect 43: A device for wireless communication, comprising a memory and one or more processors coupled to the memory, the one or more processors configured to perform the method of one or more of Aspects 23-30.

Aspect 44: A device for wireless communication, comprising a memory and one or more processors coupled to the memory, the one or more processors configured to perform the method of one or more of Aspects 31-36.

Aspect 45: An apparatus for wireless communication, comprising at least one means for performing the method of one or more of Aspects 1-11.

Aspect 46: An apparatus for wireless communication, comprising at least one means for performing the method of one or more of Aspects 12-22.

Aspect 47: An apparatus for wireless communication, comprising at least one means for performing the method of one or more of Aspects 23-30.

Aspect 48: An apparatus for wireless communication, comprising at least one means for performing the method of one or more of Aspects 31-36.

Aspect 49: A non-transitory computer-readable medium storing code for wireless communication, the code comprising instructions executable by a processor to perform the method of one or more of Aspects 1-11.

Aspect 50: A non-transitory computer-readable medium storing code for wireless communication, the code comprising instructions executable by a processor to perform the method of one or more of Aspects 12-22.

Aspect 51: A non-transitory computer-readable medium storing code for wireless communication, the code comprising instructions executable by a processor to perform the method of one or more of Aspects 23-30.

Aspect 52: A non-transitory computer-readable medium storing code for wireless communication, the code comprising instructions executable by a processor to perform the method of one or more of Aspects 31-36.

Aspect 53: A non-transitory computer-readable medium storing a set of instructions for wireless communication, the set of instructions comprising one or more instructions that, when executed by one or more processors of a device, cause the device to perform the method of one or more of Aspects 1-11.

Aspect 54: A non-transitory computer-readable medium storing a set of instructions for wireless communication, the set of instructions comprising one or more instructions that, when executed by one or more processors of a device, cause the device to perform the method of one or more of Aspects 12-22.

Aspect 55: A non-transitory computer-readable medium storing a set of instructions for wireless communication, the set of instructions comprising one or more instructions that, when executed by one or more processors of a device, cause the device to perform the method of one or more of Aspects 23-30.

Aspect 56: A non-transitory computer-readable medium storing a set of instructions for wireless communication, the set of instructions comprising one or more instructions that, when executed by one or more processors of a device, cause the device to perform the method of one or more of Aspects 31-36.

The foregoing disclosure provides illustration and description, but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a processor is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
memory;
one or more processors coupled to the memory; and
instructions stored in the memory and operable, when executed by the one or more processors, to cause the UE to:
receive, from a base station, information identifying uplink and downlink transmission opportunities that are based at least in part on downlink traffic from an application server;
communicate the uplink and downlink transmission opportunities to an application client connected to the UE via a cross-layer application programming interface (API); and
transmit one or more uplink communications including traffic from the application client in one or more of the uplink and downlink transmission opportunities.

2. The UE of claim 1, wherein the traffic from the application client is output from the application client during the uplink and downlink transmission opportunities.

3. The UE of claim 1, wherein the application client alters arrival times of the traffic from the application client in a buffer of the UE to match the uplink and downlink transmission opportunities.

4. The UE of claim 1, wherein the uplink and downlink transmission opportunities include connected mode discontinuous reception (CDRX) ON times that are aligned with transmissions of the downlink traffic from the application server.

5. The UE of claim 4, wherein the instructions operable to cause the UE to receive the information identifying the uplink and downlink transmission opportunities, when executed by the one or more processors, are operable to cause the UE to:
receive an indication of one or more CDRX parameters that identify the CDRX ON times that are aligned with the transmissions of the downlink traffic from the application server.

6. The UE of claim 1, wherein the information includes indications for the UE to switch between a first bandwidth part (BWP) for times associated with transmissions of the downlink traffic from the application server and a second BWP during gaps between the transmissions of the downlink traffic from the application server, and wherein the second BWP is associated with a lower power consumption than the first BWP.

7. The UE of claim 6, wherein the instructions operable to cause the UE to receive the information identifying the uplink and downlink transmission opportunities, when executed by the one or more processors, are operable to cause the UE to:
receive downlink control information including the indications to switch between the first BWP and the second BWP.

8. The UE of claim 6, wherein the instructions are further operable, when executed by the one or more processors, to cause the UE to:
identify the transmission opportunities based at least in part on a BWP switching pattern determined from the indications to switch between the first BWP and the second BWP, wherein the transmission opportunities include predicted times at which the UE will switch to the first BWP.

9. The UE of claim 1, wherein the transmission opportunities include times associated with a periodic uplink grant aligned with the downlink transmissions of the traffic from the application server.

10. The UE of claim 1, wherein the transmission opportunities include one or more times associated with one or more uplink configured grants that are aligned with one or more of the downlink transmissions of the traffic from the application server.

11. The UE of claim 1, wherein the application client is a virtual reality or augmented reality application client, and wherein the application server is a virtual reality or augmented reality application server.

12. A user equipment (UE) for wireless communication, comprising:
memory;
one or more processors coupled to the memory; and
instructions stored in the memory and operable, when executed by the one or more processors, to cause the UE to:
transmit, to a base station, uplink transmissions including traffic from an application client connected to the UE; and
transmit, to the base station, information identifying uplink and downlink transmission opportunities that are based at least in part on the uplink transmissions including the traffic from the application client.

13. The UE of claim 12, wherein the instructions are further operable, when executed by the one or more processors to cause the UE to:
receive, from the application client and via a cross-layer application programming interface (API), uplink traffic features associated with the traffic from the application client, wherein the uplink and downlink transmission opportunities are determined based at least in part on the uplink traffic features.

14. The UE of claim 12, wherein the instructions are further operable, when executed by the one or more processors to cause the UE to:
detect uplink traffic features associated with the traffic from the application client, wherein the uplink and downlink transmission opportunities are determined based at least in part on the uplink traffic features.

15. The UE of claim 12, wherein the uplink and downlink transmission opportunities include connected mode discontinuous reception (CDRX) ON times that are aligned with the uplink transmissions of the traffic from the application client, and wherein the information includes an indication of recommended CDRX parameters that identify the CDRX ON times that are aligned with the uplink transmissions of the traffic from the application client.

16. The UE of claim 15, wherein the instructions operable to cause the UE to transmit the information identifying the uplink and downlink transmission opportunities are operable, when executed by the one or more processors, to cause the UE to:
transmit, to the base station, a radio resource control message including the indication of the recommended CDRX parameters.

17. The UE of claim 12, wherein the instructions are further operable, when executed by the one or more processors to cause the UE to:
receive, from the base station, one or more downlink communications including traffic from an application server during one or more of the downlink transmission opportunities.

18. The UE of claim 12, wherein the instructions operable to cause the UE to transmit the information identifying the uplink and downlink transmission opportunities are operable, when executed by the one or more processors, to cause the UE to:
transmit, to the base station, uplink traffic features associated with the traffic from the application client.

19. The UE of claim 12, wherein the application client is a virtual reality or augmented reality application client.

20. A method of wireless communication performed by a user equipment (UE), comprising:
receiving, from a base station, information identifying uplink and downlink transmission opportunities that are based at least in part on downlink traffic from an application server;
communicating the uplink and downlink transmission opportunities to an application client connected to the UE via a cross-layer application programming interface (API); and
transmitting one or more uplink communications including traffic from the application client in one or more of the uplink and downlink transmission opportunities.

21. The method of claim 20, wherein the traffic from the application client is output from the application client during the uplink and downlink transmission opportunities.

22. The method of claim 20, wherein the application client alters arrival times of the traffic from the application client in a buffer of the UE to match the uplink and downlink transmission opportunities.

23. The method of claim 20, wherein the uplink and downlink transmission opportunities include connected mode discontinuous reception (CDRX) ON times that are aligned with transmissions of the downlink traffic from the application server.

24. The method of claim 23, wherein receiving the information identifying the uplink and downlink transmission opportunities comprises:
receiving an indication of one or more CDRX parameters that identify the CDRX ON times that are aligned with the transmissions of the downlink traffic from the application server.

25. The method of claim 20, wherein the information includes indications for the UE to switch between a first bandwidth part (BWP) for times associated with transmissions of the downlink traffic from the application server and a second BWP during gaps between the transmissions of the downlink traffic from the application server, and wherein the second BWP is associated with a lower power consumption than the first BWP.

26. The method of claim 25, further comprising:
identifying the transmission opportunities based at least in part on a BWP switching pattern determined from the indications to switch between the first BWP and the second BWP, wherein the transmission opportunities include predicted times at which the UE will switch to the first BWP.

27. A method of wireless communication performed by a user equipment (UE), comprising:
transmitting, to a base station, uplink transmissions including traffic from an application client connected to the UE; and
transmitting, to the base station, information identifying uplink and downlink transmission opportunities that are based at least in part on the uplink transmissions including the traffic from the application client.

28. The method of claim 27, further comprising:
receiving, from the application client and via a cross-layer application programming interface (API), uplink traffic features associated with the traffic from the application client, wherein the uplink and downlink transmission opportunities are determined based at least in part on the uplink traffic features.

29. The method of claim 27, further comprising:
detecting uplink traffic features associated with the traffic from the application client, wherein the uplink and downlink transmission opportunities are determined based at least in part on the uplink traffic features.

30. The method of claim 27, wherein the uplink and downlink transmission opportunities include connected mode discontinuous reception (CDRX) ON times that are aligned with the uplink transmissions of the traffic from the application client, and wherein the information includes an indication of recommended CDRX parameters that identify the CDRX ON times that are aligned with the uplink transmissions of the traffic from the application client.
